(19) United States
(12) Patent Application Publication
(10) Pub. No.: US 2024/0280551 A1
(43) Pub. Date: Aug. 22, 2024

(54) SYSTEM SUITABILITY PARAMETERS AND COLUMN AGING

(71) Applicant: Regeneron Pharmaceuticals, Inc., Tarrytown, NY (US)

(72) Inventors: Shao-Chung Wang, Briarcliff Manor, NY (US); Tse-Hong Chen, White Plains, NY (US); Kenneth S. Graham, Pleasant Valley, NY (US)

(21) Appl. No.: 18/584,313

(22) Filed: Feb. 22, 2024

Related U.S. Application Data
(60) Provisional application No. 63/447,533, filed on Feb. 22, 2023.

(51) Int. Cl. G01N 30/88; G01N 30/02; G01N 30/96

(52) U.S. Cl. CPC G01N 30/88; G01N 2030/027; G01N 2030/889; G01N 30/96

(57) ABSTRACT

The inventions provide methods for monitoring column performance and operating chromatography column by applying generalized linear model to system suitability parameters (SSPs) to assess how fast the column is aging and whether the column stationary phase needs to be replaced. The methods will lead to faster identification of column failures and help maintain high separation quality and consistent analytical results for analytical and preparative chromatography methods. Columns evaluated and/or monitored by the methods and products resulting from use of the columns and methods also are provided.

### REFERENCE TO RELATED APPLICATIONS

This application claims the benefit of U.S. Provisional Patent Application Ser. No. 63/447,533, filed Feb. 22, 2023, the entire contents of which are incorporated herein by reference.

### FIELD OF THE INVENTIONS

The present invention generally relates to chromatography, and more specifically methods to operate and monitor chromatography columns and the products resulting from the use of such chromatography columns.

### BACKGROUND

In the biopharmaceutical industry, preparative chromatography using packed-bed columns is a key component in the manufacture of complex biological products (for example, recombinant proteins and antibodies). In particular, the success of monoclonal antibodies is attributable to their target specificity and favorable side effect profiles, which are typically minimal when compared to other therapeutic modalities, and monoclonal antibodies have been developed to successfully treat a variety of human diseases, including cancers, infections, and inflammation. However, despite the progress made in the selection of therapeutic targets for monoclonal antibodies, challenges remain in manufacturing processes, formulation development, and product stability during storage (S. Goswami et al. Developments and challenges for mAb-based therapeutics. Antibodies 2 (2013) 452-500).

Control of aggregation is one of the critical challenges encountered during the formulation and process development of protein-based drugs, including monoclonal antibodies. The partial unfolding states of monoclonal antibody monomers, which are accompanied by conformational changes in structure, are believed to drive the formation of aggregates via self-association. These aggregates, which range from dimer and trimer to higher-ordered oligomerization states, pose potential threats to drug safety and efficacy (Y. L. et al., Physicochemical stability of monoclonal antibodies: A review. J. Pharm. Sci. 109 (2020) 169-190). The intended biological activity of monoclonal antibodies has been reported to negatively correlate with the presence of aggregates (R. Bansal, R. Dash, A. S. Rathore, Impact of mAb aggregation on its biological activity: Rituximab as a case study. J. Pharm. Sci. 109 (2020) 2684-2698). Additionally, these aggregates can lead to formation of insoluble particulates that impact the drug quality (e.g., opalescence) (B. A. Salinas et al., Understanding and modulating opalescence and viscosity in a monoclonal antibody formulation. J. Pharm. Sci. 99 (2010) 82-93) and induce undesirable immune responses (X. Wang et al., Molecular and functional analysis of monoclonal antibodies in support of biologics development. Protein Cell 9 (2018) 74-58). Therefore, aggregate level is considered a critical quality attribute (CQA) and must be closely monitored throughout monoclonal antibody development and production.

Silica- or polymer-based particles are commonly used to pack chromatography columns, and the surface of the particles are often modified according to the chromatography methods. Surface modification of the silica particle involves several chemical reactions to create covalent bonds between functional groups and the silanol groups on the silica surface (E. M. Borges, Silica, Hybrid Silica, Hydride Silica and Non-Silica Stationary Phases for Liquid Chromatography. J. Chromatogr. Sci. 53 (2015) 580-597). However, due to inherent delicateness of the particles or repeated exposure to various analytical conditions (for example, changes of mobile phases, sample compositions, pressure), changes or loss of the modified functional groups can alter the interactions of the column particles with the sample compositions. It has been reported that the efficiency of surface modification can vary resulting in unmodified and isolated silanol groups that can be potential liabilities. The isolated silanols, also known as active silanols, induce strong electrostatic interactions with biomolecules and result in peak tailing, peak broadening, and asymmetry. In addition to secondary interactions from active silanol groups, another challenge is ensuring the uniformity of pore sizes and the consistency of modifying chemical groups (S. Fekete et al., Size exclusion chromatography of protein biopharmaceuticals: past, present and future. Am. Pharm. Rev. (2018) 1-4). Consequently, resolution and/or separation efficiency of the column may be significantly reduced. Accordingly, it is critical that chromatography column performance is closely monitored and well controlled to ensure high product quality of biomolecular products.

Therefore, there is a need in the field for methods to monitor column performance to facilitate high-performance of the column.

### SUMMARY OF THE INVENTIONS

The present disclosure provides methods for operating a chromatography column, comprising performing generalized linear model (GLM) to a set of values of a system suitability parameter (SSP), wherein the set of values of the SSP is obtained from an initial run and one or more subsequent runs of an analyte through the columns.

The slope of the linear regression line produced by the GLM can indicate performance of the column compared to the initial condition of the column at the initial run.

The methods can comprise measuring the values of the SSP in the initial and subsequent runs.

The slope of the linear regression line can indicate rate of column degradation or rate of column aging.

The SSP can be selected from the group consisting of retention time, peak height and/or peak width, tailing factor, asymmetry factor, resolution, plate count, or any combination thereof.

The methods can comprise making a determination that the performance of the column is acceptable if the set of values of the SSP fits a linear model.

The methods can comprise making a determination that the performance of the column is not acceptable if the set of values of the SSP does not fit a linear model.

The set of values of the SSP can fit an exponential model better than a linear model.

The generalized linear model can have the following equation:

$$\hat{y} = β 0 + {β}_{1} {x}_{1} + {β}_{2} {x}_{2} ;$$

wherein x₁ is run number, ŷ is the estimated SSP value at the x₁-th run, β₀ is the estimated average intercept, β₁ is the estimated slope of the linear regression line, and β₂x₂ is the estimated correction for variability between different lots of columns, wherein β₀ and β₁ are regression coefficients that are computed to minimize residual sum of squares, optionally wherein the term β₂x₂ is removed from the GLM equation.

The methods can further comprise determining R-squared (R²) value as a goodness-of-fit measure.

The methods can comprise making a determination that the performance of the column is not acceptable if the R² value is smaller than a predetermined threshold value. The predetermined threshold value can be 0.7.

The methods can further comprise replacing the column or repacking the column stationary phase particles.

The inventions further provide methods for monitoring a column, comprising performing generalized linear model (GLM) to a set of values of a system suitability parameter (SSP), wherein the set of values of the SSP is obtained from an initial run and one or more subsequent runs of an analyte through the column.

The slope of the linear regression line produced by the GLM can indicate performance of the column compared to the initial condition of the column at the initial run.

The methods can comprise measuring the values of the SSP in the initial and subsequent runs.

The slope of the linear regression line can indicate rate of column degradation or rate of column aging.

The SSP can be selected from the group consisting of retention time, peak height and/or peak width, tailing factor, asymmetry factor, resolution, plate count, or any combination thereof.

The methods can comprise making a determination that the performance of the column is acceptable if the set of values of the SSP fits a linear model.

The methods can comprise making a determination that the performance of the column is not acceptable if the set of values of the SSP does not fit a linear model.

The set of values of the SSP can fit an exponential model better than a linear model.

The generalized linear model can be:

$$\hat{y} = β 0 + {β}_{1} {x}_{1} + {β}_{2} {x}_{2} ;$$

wherein x₁ is run number, ŷ is the estimated SSP value at the x₁-th run, β₀ is the estimated average intercept, β₁ is the estimated slope of the linear regression line, and β₂x₂ is the estimated correction for variability between different lots of columns, wherein β₀ and β₁ are regression coefficients that are computed to minimize residual sum of squares, optionally wherein the term β₂x₂ is removed from the GLM equation.

The methods can further comprise determining R-squared (R²) value as a goodness-of-fit measure.

The methods can comprise making a determination that the performance of the column is not acceptable if the R² value is smaller than a predetermined threshold value. The predetermined threshold value is 0.7.

The methods can further comprise replacing the column or repacking the column stationary phase particles.

The inventions can further provide methods for operating a chromatography column, comprising determining percent change of a SSP between an initial run and a subsequent run of an analyte through the column.

The SSP can be selected from the group consisting of retention time, peak height and/or peak width, tailing factor, asymmetry factor, resolution, plate count, or any combination thereof.

A positive percent change of retention time, peak width and/or tailing factor can indicate decreasing column performance.

A negative percent change of peak height, resolution and/or plate count can indicate decreasing column performance.

The methods can comprise making a determination that the performance of the column is not acceptable if the percent change of the SSP exceeds a reference level. The percent change can be great than 2.3% if the SSP is retention time, the percent change can be great than 12% if the SSP is peak width, the percent change can be great than 10% if the SSP is tailing factor, the percent change can be great than 15.75% if the SSP is asymmetry factor, the percent change can be smaller than −9.8% if the SSP is peak height, the percent change can be smaller than −10.5% if the SSP is resolution; and/or the percent change can be smaller than −18.5% if the SSP is plate count.

The methods can further comprise making a determination that the performance of the column is acceptable and continuing using the column.

The determination that the performance of the column is acceptable can be made when the percent change of the SSP is equal to or exceeds a reference level. The percent change can be equal to or lower than 2.3% if the SSP is retention time, the percent change can be equal to or lower than 12% if the SSP is peak width, the percent change can be equal to or lower than 10% if the SSP is tailing factor, the percent change can be equal to or lower than 15.75% if the SSP is asymmetry factor, the percent change can be equal to or greater than −9.8% if the SSP is peak height, the percent change can be equal to or greater than −10.5% if the SSP is resolution; and/or the percent change can be equal to or greater than −18.5% if the SSP is plate count.

The methods can further comprise replacing the column or repacking the column stationary phase particles.

The disclosure provides methods for monitoring a chromatography column, comprising determining percent change of a SSP between an initial run and a subsequent run of an analyte through the column.

The SSP can be selected from the group consisting of retention time, peak height and/or peak width, tailing factor, asymmetry factor, resolution, plate count, or any combination thereof.

A positive percent change of retention time, peak width and/or tailing factor can indicate decreasing column performance.

A negative percent change of peak height, resolution and/or plate count can indicate decreasing column performance.

The methods can comprise making a determination that the performance of the column is not acceptable if the percent change of the SSP exceeds a reference level. The percent change can be great than 2.3% if the SSP is retention time, the percent change can be great than 12% if the SSP is peak width, the percent change can be great than 10% if the SSP is tailing factor, the percent change can be great than 15.75% if the SSP is asymmetry factor, the percent change can be smaller than −9.8% if the SSP is peak height, the percent change can be smaller than −10.5% if the SSP is resolution, and/or the percent change can be smaller than −18.5% if the SSP is plate count.

The methods can comprise making a determination that the performance of the column is acceptable and continuing using the column.

The determination that the performance of the column is acceptable can be made when the percent change of the SSP is equal to or exceeds a reference level. The percent change can be equal to or lower than 2.3% if the SSP is retention time, the percent change can be equal to or lower than 12% if the SSP is peak width, the percent change can be equal to or lower than 10% if the SSP is tailing factor, the percent change can be equal to or lower than 15.75% if the SSP is asymmetry factor, the percent change can be equal to or greater than −9.8% if the SSP is peak height, the percent change can be equal to or greater than −10.5% if the SSP is resolution, and/or, the percent change can be equal to or greater than −18.5% if the SSP is plate count.

The methods can be further comprise replacing the column or repacking the column stationary phase particles.

The column can comprise silica-based particles or polymer-based material.

The surface of the particles can be chemically modified.

The chromatography can be selected from the group consisting of size exclusion chromatography (SEC), reversed-phase liquid chromatography (RPLC), hydrophilic interaction liquid chromatography (HILIC), hydrophobic liquid chromatography (HIC), ion-exchange chromatography (IEX), and affinity chromatography (AC).

The ion-exchange chromatography (IEX) can be anion-exchange chromatography (AEX) or cation-exchange chromatography (CEX).

The chromatography column can be a silica-based SEC column.

The analyte can be a biomolecule.

The biomolecule can be selected from the group consisting of protein, nucleic acid, carbohydrate and lipid.

The protein can be selected from the group consisting of an antibody, an enzyme, a cytokine, a growth factor, a hormone, an interferon, an interleukin, or an anti-clotting factor.

Columns evaluated and/or monitored by the methods and products resulting from use of the columns and methods also are provided.

### BRIEF DESCRIPTIONS OF THE FIGURES

Non-limiting examples of the inventions are described with reference to figures attached hereto that are listed following this paragraph.

FIG. 1 is a schematic showing degradation of silica-based particles that results in unmodified and isolated silanol groups (“active silanols”) that interact with biomolecules and result in peak tailing, peak broadening, and asymmetry.

FIG. 2A shows representative chromatogram of SEC separation on in-house IgG1 mAb.

FIG. 2B shows overlay chromatograms increase in injection counts from left (100 injections) to right (1250 injections). Insert: Zoomed-in and overlayed chromatograms with alignment of main peak.

FIGS. 3A-3G show control charts plotting SSPs as a function of time from a single column. The points represent the mean of each SSP corresponding to 10, 118, 207, 500, 630 and 840 injections. FIG. 3A: % area; FIG. 3B: USP tailing factor; FIG. 3C: peak width at 5% height; FIG. 3D: asymmetry factor; FIG. 3E: retention time; FIG. 3F: USP resolution; FIG. 3G: USP plate count.

FIGS. 4A-4G show linear regression correlation between system suitability parameters and column injection counts. FIG. 4A: Retention time; FIG. 4B: Peak width at 5% height; FIG. 4C: Peak height; FIG. 4D: Tailing factor; FIG. 4E: Asymmetry factor; FIG. 4F: Resolution; FIG. 4G: Plate count. Solid lines represent the common regression line of the general linear model.

FIG. 5 shows percent change of system suitability parameters over injection counts for peak width, tailing factor, retention time, area percent, peak height, resolution, and plate count, in the order of top to bottom lines.

FIGS. 6A-6B show a schematic of the column performance evaluation processes (FIG. 6A) and point of decision to replace columns if the parameters of the column profile (% area, retention time, height, USP resolution, USP plate count) fall out of the control limits (FIG. 6B). In FIG. 6A, the middle panel depicting a non-limiting example of SSP changes, the circles highlight the changes in the small peak which exhibits increasingly poorer resolution over increasing injection number. In FIG. 6B, a column is determined as failing to perform after a certain number of runs/injections when characteristics critical for column quality meet a failure point. TDB: injection number to be determined when column fails to perform.

FIG. 7 shows a non-limiting exemplary scenario in which a column approaches the end of its life span and system suitability parameters (SSP) deviate from linear behavior. When column condition is acceptable, the SSP and the percent change of the SSP compared to the initial condition fit a linear model (for example, after up to ˜1300 runs as shown in the graph). When column deterioration becomes worse quickly at the use limit of the column, the SSP change over injection count is expected to have an exponential relationship.

### DETAILED DESCRIPTION OF THE INVENTIONS

It should be appreciated that the inventions are not limited to the compositions and methods described herein as well as the experimental conditions described, as such may vary. It is also to be understood that the terminology used herein is for the purpose of describing the inventions, and is not intended to be limiting.

Unless defined otherwise, all technical and scientific terms used herein have the same meaning as commonly understood by one of ordinary skill in the art to which these inventions belong. Although any compositions, methods and materials similar or equivalent to those described herein can be used in the practice or testing of the present invention. All publications mentioned are incorporated herein by reference in their entirety.

Recitation of ranges of values herein are merely intended to serve as an efficient method of referring individually to each separate value falling within the range, unless otherwise indicated herein, and each separate value is incorporated into the specification as if it were individually recited herein.

### A. Definitions

As used herein, the term “about” in the context of numerical values and ranges refers to values or ranges that approximate or are close to the recited values or ranges such that the invention can perform as intended, such as having a desired rate, amount, degree, increase, decrease, concentration, or time, for example, as is apparent from the teachings contained herein. Thus, this term encompasses values beyond those simply resulting from systematic error.

As used herein, “asymmetry factor” refers to a common measure of peak distortion. Asymmetry factor (As) can be used to evaluate peak tailing and peak fronting as an indicator of the loss of column quality. In some instances, asymmetry factor can be defined as

$${A}_{s} = \frac{b}{a} ,$$

where a and b are the first and the second half-width at 10% of the maximum peak height of the target peak, respectively.

As used herein, the term “analyte” refers to a substance to be separated during chromatography.

As used herein, the term “biomolecule” or “biological molecule” refer to a molecule produced by cells and living organisms. Biomolecules have a wide range of sizes and structures and perform a vast array of functions. The four major types of biomolecules are carbohydrates, lipids, nucleic acids, and proteins. However, many biomolecules comprises moieties from different categories, such as proteoglycans and glycoproteins, which are proteins comprising carbohydrate moieties.

As used herein, the term “chromatography” refers to a technique that enables the separation of a mixture into its components. Chromatography is based on the principle that, molecules in a mixture are carried by a fluid solvent, called mobile phase, through a system comprising a material that is fixed, called stationary phase. Because the different components of the mixture tend to have different affinities for the stationary phase and are retained for different lengths of time depending on their interactions, the components travel at different apparent velocities in the mobile fluid, causing them to separate.

Chromatography can be used for separation of components for later use (in other words, purification) and/or analyzing components of a mixture. Chromatography methods are well-known in the art, and many methods are frequently used for purification and analytical purposes. For example, based on the physical state of the mobile phase, the chromatography can be gas chromatography or liquid chromatography (see, for example, Analytical Separation Science (2015) published by Weinheim: Wiley-VCH). Based on the shape of the stationary phase, chromatographic methods include column chromatography or planar chromatography (for example, paper chromatography, thin-layer chromatography). Based on separation mechanism, a range of chromatographic methods exist, including but not limited to size exclusion chromatography (SEC), reversed-phase chromatography (RPC/RPLC), hydrophilic interaction liquid chromatography (HILIC), hydrophobic liquid chromatography (HIC), ion-exchange chromatography (IEX) and affinity chromatography (AC).

As used herein, “chromatograph” refers to instruments used to conduct the chromatography process.

As used herein, “column chromatography” refers to chromatography methods in which the stationary phase is packed within a tube or a column. The stationary phase materials can be referred to in the field interchangeably as “resins”, “beads” or “particles”. The particles of the solid stationary phase or the support coated with a liquid stationary phase may fill the whole inside volume of the tube (packed column) or be concentrated on or along the inside tube wall leaving an open, unrestricted path for the mobile phase to move through in the middle part of the tube. Typically, the particles are tightly packed in a tube or column in a manner to minimize interstitial volume between the particles so as to increase the separation efficiency of the column.

Typically, a column is first packed with the stationary particles and filled with a mobile phase. Once the column is prepared for an analysis or a run, a sample is loaded onto the top of the packed column. In many chromatography systems, a series of tubes and pumps are connected to the column to create pressure to push solvents (for example, the mobile phase) through the column, and the sample is injected into the system to be loaded onto the column. The term “injection” as used herein refers to sample loading or a run of a sample through the column. The term “injection count” can be understood as the number of runs or analyses performed with a column.

A detector is used to monitor separation of analytes in a sample as the analytes move through the chromatography column The detector is typically positioned where the analytes are eluted off the column. Methods of detection are selected according to the type of analytes and chromatography techniques, and include but are not limited to UV, fluorescence, refractive index, conductivity, thermal conductivity, electron capture, and photoionization detection.

Measurement of only the elution solvent by the detector is used to establish a baseline, and the response of the detector to the analytes are often recorded as a series of peaks rising from the baseline. Each peak represents a compound. Many characteristics of the peaks such as peak width, peak height, peak area, symmetry/asymmetry, and separation/overlap of neighboring peaks, are used to evaluate the analytes as well as the efficiency of the chromatography run.

As used here in, “general linear model” refers to a multivariate statistical analysis used for the comparison of two sets of variables of a model function, and covers linear regression and normal distribution situations. The general linear model is often used for analysis of measurement data in many fields, for example, comparison of a set of measured observations with time. As used herein, a “generalized linear model” is an extension of a general linear model, which could cover linear/non-linear regression and normal/non-normal distribution.

As used herein, “mobile phase” refers to the phase that moves in a definite direction in chromatography. The mobile phase is fluid, for example, a liquid or a gas. The mobile phase comprises the sample being separated/analyzed and the solvent that moves the sample through the stationary phase.

As used herein, the terms “peptide,” “polypeptide,” and “protein” are used interchangeably and refer to a polymeric form of amino acids of any length, which can include coded and non-coded amino acids, chemically or biochemically modified or derivatized amino acids, and polypeptides having modified peptide backbones.

As used herein, “plate count” refers to a theoretical number describing the separation efficiency of a chromatography column. In some instances, plate count is defined as

$$N = 16 {( \frac{R t}{W} )}^{2}$$

where Rt is the retention time for the analyte and W is the tangent width of the monomer peak at baseline (according to the United States Pharmacopoeia (USP)).

As used herein, “purifying” means a process performed to isolate an analyte (for example, a biological molecule such as a peptide, protein, oligonucleotide, DNA, RNA etc.) from one or more other impurities or components present in a fluid. Purification can be performed using a chromatography method.

As used herein, “reference level” refers to a level change in one or more SSPs that is indicative of critical column aging, critical column degradation, and/or poor column performance such that the column should be replaced.

As used herein, “resolution” refers to the degree of separation between two eluting peaks based on their retention times and peak widths in a chromatogram. In some instances, a measurement for resolution can be defined as

$${R}_{s} = \frac{2 ( R {f}_{2} - R {f}_{1} )}{( {W}_{2} + {W}_{1} )} ,$$

where Rt₂ and Rt₁ are the retention time for peaks of low molecular weight species (LMWS) and monomer peaks of an antibody, respectively, and W₂ and W₁ are the peak widths at the baseline between tangent lines drawn at 50% of the antibody's LMWS and monomer peak height, respectively.

As used herein, “sample” refers to a mixture of compounds obtained from any source. The compounds in the sample are separated using a chromatography method.

The term “such as” is used herein to mean, and is used interchangeably, with the phrase “such as but not limited to.”

As used herein, “retention time” refers to a measurement of the time required for a molecule to pass through the separation system, from injection to detection. Herein, “retention time” and “elution time” are used interchangeably.

As used herein, “stationary phase” refers to the substance that is fixed in place for the chromatography process. While the mobile phase moves in one direction, the analytes in the sample interact with the stationary phase to different degree and therefore separated.

As used herein, “system suitability parameter” (SSP) refers to a measurement used to verify the system performance. In chromatography, SSPs include, but are not limited to, asymmetry, retention time, resolution, plate count, peak width, peak height, peak area, tailing factor, selectivity and detection limit.

As used herein, “tailing factor”, also known as “symmetry factor”, refers to a measurement of peak tailing which shows the degree of peak symmetry. USP tailing factor (T_{f}) can be expressed as

$${T}_{f} = \frac{a + b}{2 a} ,$$

where a and b are the first and the second half-width at 5% of the maximum peak height of the target peak, respectively.

All numerical limits and ranges set forth herein include all numbers or values thereabout or there between of the numbers of the range or limit. The ranges and limits described herein expressly denominate and set forth all integers, decimals and fractional values defined and encompassed by the range or limit. The ranges and limits described herein expressly denominate and set forth all integers, decimals and fractional values defined and encompassed by the range or limit. Thus, a recitation of ranges of values herein are merely intended to serve as an efficient method of referring individually to each separate value falling within the range, unless otherwise indicated herein, and each separate value is incorporated into the specification as if it were individually recited herein. For example, a range of 1 to 50 is understood to include any number, including fractional values, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Reference will now be made in detail to examples of the inventions. While the inventions will be described in conjunction with examples, it will be understood that it is not intended to limit the invention to those examples. To the contrary, it is intended to cover alternatives, modifications, and equivalents as may be included within the spirit and scope of the invention as defined by the appended claims.

### B. Methods

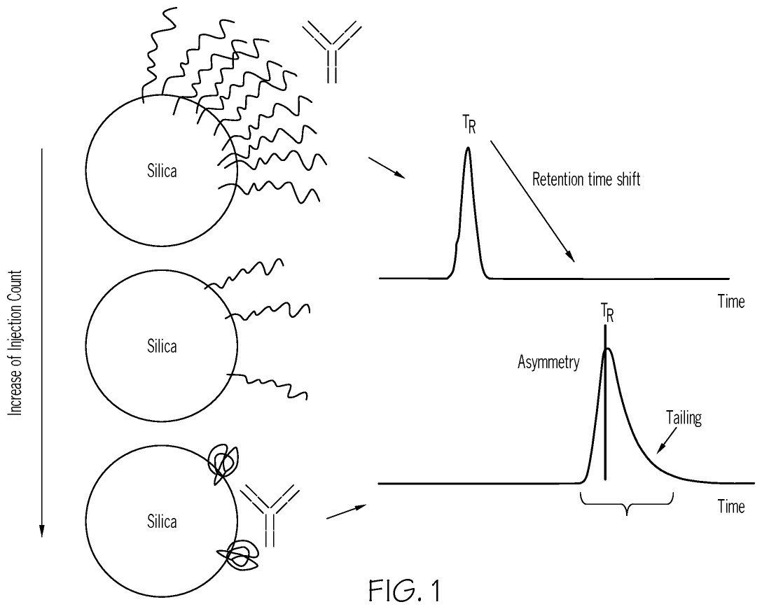

FIG. 1 depicts degradation of silica-based particles that results in unmodified and isolated silanol groups (“active silanols”) that interact with biomolecules and cause peak tailing, peak broadening, and asymmetry, which result in performance decline caused by usage.

In view of the performance decline, methods and systems for operating, evaluating and/or monitoring chromatography column performance are needed and are provided herein.

### 1. Methods of Monitoring and Operating Chromatography Column

The inventive methods described herein are based on the important findings that careful examination of SSPs before and throughout column use revealed that SSPs are critical tools to detect column aging and performance. Monitoring the changes in SSPs over time helps to establish realistic and historical data-based acceptance criteria to determine when a column should be replaced. Another approach is utilizing the percent change and the estimated intercept obtained from the linear regression between SSPs and injection number to predict how fast a column is aging or to screen and assess the initial performance of a new column. Replicate injections of in-house test standards on multiple columns and the establishment of long-term, internal control criteria for SSPs ensure consistent analytical results and will lead to faster identification of column failures, more efficient production, and higher quality products.

The present disclosure provides methods for monitoring and operating one or more chromatography columns based on the discovery that several critical system suitability parameters (SSPs) strongly correlate with the age of the columns. This surprising observation points to a rigorous approach to qualify the columns and predict their long-term performance.

The methods are provided for assessing chromatography column performance, column aging and/or column degradation. The methods can comprise performing generalized linear model (GLM) to a set of values of a system suitability parameter (SSP), wherein the set of values of the SSP is obtained from an initial run and one or more subsequent runs of an analyte through the column.

The methods are also provided for monitoring chromatography column performance, column aging and/or column degradation. The methods can comprise performing generalized linear model (GLM) to a set of values of a system suitability parameter (SSP), wherein the set of values of the SSP is obtained from an initial run and one or more subsequent runs of an analyte through the column.

The methods are provided for predicting chromatography column performance, column aging and/or column degradation. The methods can comprise performing generalized linear model (GLM) to a set of values of a system suitability parameter (SSP), wherein the set of values of the SSP is obtained from an initial run and one or more subsequent runs of an analyte through the column.

The methods are provided for operating a chromatography column. The methods can comprise performing generalized linear model (GLM) to a set of values of a system suitability parameter (SSP), wherein the set of values of the SSP is obtained from an initial run and one or more subsequent runs of an analyte through the column.

The system suitability parameter (SSP) can be selected from the group consisting of retention time, peak height, peak width, tailing factor, asymmetry factor, resolution, and plate count. Methods for determining common SSPs are routine and well known in the field (see, for example, Sankar, Ravi. (2019). Fundamental Chromatographic Parameters. International Journal of Pharmaceutical Sciences Review and Research. 55(2): 46-50).

Preferably, at least 3 values are obtained for a set of values of the SSP. The number of values in a set is at least 10, 20, 30, 40, 50, 75, 100, 150, 200, 250, 300, 350, 400, 450 or 500 values.

A value of the SSP can be obtained for a column at an initial condition. The initial condition of the column is when the column performance is optimal, before usage of the column wears down and negatively impact the quality of the column. The run to obtain SSP values for the initial condition is designated to have a run number of 0.

After a value of the SSP is obtained at an initial condition, subsequent values of the SSPs are obtained after the column has been subjected to one or more separation processes, (i.e., runs, or injection counts).

The values of the SSP are obtained after about more than 10, 20, 30, 40, 50, 60, 70, 80 90 or 100 runs. The values of the SSP are obtained after about more than 100, 200, 300, 400, 500, 600, 700, 800, 900, 1000, 1100, 1200, 1300, 1400 or 1500 runs.

SSP values for use in the methods disclosed herein can be obtained from replicate runs of the same sample. The SSP values can be obtained from runs of samples comprising the same analyte.

The methods can comprise measuring the SSP values. The methods can comprise obtaining the SSP values.

In the methods provided herein, the values of a SSP can be fitted using generalized linear model (GLM) to correlate the measured values of the SSP with the number of runs (or injections) that the column has undergone.

The generalized linear model (GLM) can have the following equation:

$$\hat{y} = {β}_{0} + {β}_{1} {x}_{1} + {β}_{2} {x}_{2} ; \qquad ( Equation I )$$

wherein ŷ is the estimated SSP responses, x₁ is run/injection number, and x₂ is grouped column lots, β₀ is the estimated average intercept (column initial condition), β₁ is the slope (the rate of column deterioration). β₂x₂ is the computed coefficient from different columns. β₀ can be interpreted as the average initial conditions for SSPs of a selected column, which is determined by its manufacturing process.

Methods to fit a dataset to a generalized linear modeling are known in the art. A software can be used to fit the set of SSP values to a GLM and generate the coefficients of Equation I. For example, a software useful for the instant methods is JMP®, and the set of SSP values can be fit to a linear model using the “Standard Least Square Model” of JMP®.

R-squared value can be further obtained for fitting the set of SSP values to the GLM. R-squared (R² or the coefficient of determination) is a statistical measure in a regression model that determines the proportion of variance in the dependent variable that can be explained by the independent variable. In other words, R² value can show how well the data fit the regression model (the goodness of fit).

The slope of the linear regression line can be obtained from the generalized linear model indicates rate of column aging and/or column degradation.

The methods can comprise determining if values of the SSP fit a linear model.

The methods can comprise making a determination that the performance of the column is not acceptable if the set of values of the SSP does not fit a linear model. The set of values of the SSP can be determined to fit an exponential model better than a linear model.

The methods can comprise making a determination that the performance of the column is acceptable if the set of values of the SSP fits a linear model.

The methods can comprise determining if the set of values of the SSP fit a linear model based on the R² value. The set of values of the SSP can be determined to not fit a linear model if the R² value is smaller than a predetermined threshold value.

The methods can comprise making a determination that the performance of the column is not acceptable if the R² value is smaller than a predetermined threshold value.

The predetermined threshold value for R² can be 0.9, 0.89, 0.88, 0.87, 0.86, 0.85, 0.84, 0.83, 0.82, 0.81, 0.8, 0.79, 0.78, 0.77, 0.76, 0.75, 0.74, 0.73, 0.72, 0.71, 0.7, 0.69, 0.68, 0.67, 0.66, 0.65, 0.64, 0.63, 0.62, 0.61, 0.6, 0.59, 0.58, 0.57, 0.56, 0.55, 0.54, 0.53, 0.52, 0.51, 0.5, 0.49, 0.48, 0.47, 0.46, 0.45, 0.44, 0.43, 0.42, 0.41, or 0.4. The predetermined threshold for R² can be 0.7.

The methods can comprise making a determination that the performance of the column is not acceptable if the R² value is smaller than 0.7.

Certain features of the methods disclosed herein can comprise determining percent change of a SSP after a number of runs compared to the SSP value at the initial condition.

A positive percent change of retention time, peak width and/or tailing factor can indicate decreasing column performance.

A negative percent change of peak height, resolution and/or plate count can indicate decreasing column performance.

The methods can comprise making a determination that the performance of the column is not acceptable if the percent change of the SSP exceeds a reference level. The methods can comprise making a determination that the performance of the column is acceptable if the percent change of the SSP is equal to or below a reference level.

When the SSP is retention time, the reference level can be about 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.5% or 5%. A determination that the performance of the column is not acceptable can be made when the percent change in retention time is greater than 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.5% or 5%. A determination that the performance of the column is acceptable can be made when the percent change in retention time is equal to or lower than 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.5% or 5%.

When the SSP is peak width (e.g., peak width at 5% peak height), the reference level can be about 6%, 6.5%, 7%. 7.5%, 8%, 8.5%, 9%, 9.5%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%. A determination that the performance of the column is not acceptable can be made when the percent change in peak width is greater than 6%, 6.5%, 7%. 7.5%, 8%, 8.5%, 9%, 9.5%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%. A determination that the performance of the column is acceptable can be made when the percent change in peak width is equal to or lower than 6%, 6.5%, 7%. 7.5%, 8%, 8.5%, 9%, 9.5%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%.

When the SSP is tailing factor, the reference level can be about 5%, 6%, 7%, 8%, 9%, 9.2%, 9.4%, 9.5%, 9.6%, 9.8%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%. A determination that the performance of the column is not acceptable can be made when the percent change in tailing factor is greater than 5%, 6%, 7%, 8%, 9%, 9.2%, 9.4%, 9.5%, 9.6%, 9.8%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%. A determination that the performance of the column is acceptable can be made when the percent change in tailing factor is equal to or lower than 5%, 6%, 7%, 8%, 9%, 9.2%, 9.4%, 9.5%, 9.6%, 9.8%, 10%, 10.2%, 10.4%, 10.5%, 10.6%, 10.8%, 11%, 11.2%, 11.4%, 11.5%, 10.6%, 10.8%, 12%, 12.2%, 12.4%, 12.5%, 12.6%, 12.8%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5% 15.6%, 15.8% 16%, 16.5%, 17%, 17.5%, 18%, 18.5%, 19%, 19.5%, or 20%.

When the SSP is asymmetry factor, the reference level can be about 7%, 7.5%, 8%, 8.5%, 9%, 9.5%, 10%, 10.5%, 11%, 11.5%, 12%, 12.5%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5%, 15.6%, 15.8%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5% or 30%. A determination that the performance of the column is not acceptable can be made when the percent change in asymmetry factor is greater than 7%, 7.5%, 8%, 8.5%, 9%, 9.5%, 10%, 10.5%, 11%, 11.5%, 12%, 12.5%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5%, 15.6%, 15.8%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5% or 30%. A determination that the performance of the column is acceptable can be made when the percent change in asymmetry factor is equal to or lower than 7%, 7.5%, 8%, 8.5%, 9%, 9.5%, 10%, 10.5%, 11%, 11.5%, 12%, 12.5%, 13%, 13.2%, 13.4%, 13.5%, 13.6%, 13.8%, 14%, 14.2%, 14.4%, 14.5%, 14.6%, 14.8%, 15%, 15.2%, 15.4%, 15.5%, 15.6%, 15.8%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5% or 30%.

When the SSP is peak height, the reference level can be about −4%, −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%. A determination that the performance of the column is not acceptable can be made when the percent change in peak height is lower than −4%, −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%. A determination that the performance of the column is acceptable can be made when the percent change in peak height is equal to or greater than −4%, −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%.

When the SSP is resolution, the reference level can be about −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%. A determination that the performance of the column is not acceptable can be made when the percent change in resolution is lower than −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%. A determination that the performance of the column is acceptable can be made when the percent change in resolution is equal to or greater than −4.5%, −5%, −5.5%, −6%, −6.5%, −7%, −8%, −8.5%, −9%, −9.2%, −9.4%, −9.5%, −9.6%, −9.8%, −10%, −10.2%, −10.4%, −10.5%, −10.6%, −10.8%, −11%, −11.2%, −11.4%, −11.5%, −10.6%, −10.8%, −12%, −12.2%, −12.4%, −12.5%, −12.6%, −12.8%, −13%, −13.2%, 1−3.4%, −13.5%, −13.6%, −13.8%, −14%, −14.2%, −14.4%, −14.5%, −14.6%, −14.8%, −15%, −15.2%, −15.4%, −15.5%, −15.6%, −15.8%, −16%, −16.5%, −17%, −17.5%, −18%, −18.5%, −19%, −19.5%, or −20%.

When the SSP is plate count, the reference level can be about −9%, −9.5%, −10%, −10.5%, −11%, −11.5%, −12%, −12.5%, −13%, −13.5%, −14%, −14.5%, −15%, −15.2%, −15.4%, −15.5%, −15.6%, −15.8%, −16%, −16.5%, −17%, −17.5%, −18%, −18.5%, −19%, −19.5%, −20%, −20.5%, −21%, −21.5%, −22%, −22.5%, −23%, −23.5%, −24%, −24.5%, −25%, −25.5%, −26%, −26.5%, −27%, −27.5%, −28%, −28.5%, −29%, −29.5%, −30%, −30.5%, −31%, −31.5%, −32%, −32.5%, −33%, −33.5%, −34%, −34.5%, −35%, −35.5%, −36%, −37%, −38%, −39% or −40%. A determination that the performance of the column is not acceptable can be made when the percent change in plate count is lower than −9%, −9.5%, −10%, −10.5%, −11%, −11.5%, −12%, −12.5%, −13%, −13.5%, −14%, −14.5%, −15%, −15.2%, −15.4%, −15.5%, −15.6%, −15.8%, −16%, −16.5%, −17%, −17.5%, −18%, −18.5%, −19%, −19.5%, −20%, −20.5%, −21%, −21.5%, −22%, −22.5%, −23%, −23.5%, −24%, −24.5%, −25%, −25.5%, −26%, −26.5%, −27%, −27.5%, −28%, −28.5%, −29%, −29.5%, −30%, −30.5%, −31%, −31.5%, −32%, −32.5%, −33%, −33.5%, −34%, −34.5%, −35%, −35.5%, −36%, −37%, −38%, −39% or −40%. A determination that the performance of the column is acceptable can be made when the percent change in plate count is equal to or greater than −9%, −9.5%, −10%, −10.5%, −11%, −11.5%, −12%, −12.5%, −13%, −13.5%, −14%, −14.5%, −15%, −15.2%, −15.4%, −15.5%, −15.6%, −15.8%, −16%, −16.5%, −17%, −17.5%, −18%, −18.5%, −19%, −19.5%, −20%, −20.5%, −21%, −21.5%, −22%, −22.5%, −23%, −23.5%, −24%, −24.5%, −25%, −25.5%, −26%, −26.5%, −27%, −27.5%, −28%, −28.5%, −29%, −29.5%, −30%, −30.5%, −31%, −31.5%, −32%, −32.5%, −33%, −33.5%, −34%, −34.5%, −35%, −35.5%, −36%, −37%, −38%, −39% or −40%.

A criteria for one or more SSPs can be established to evaluate column performance and identify column failure.

The performance of the column can be evaluated based on more than one SSPs. Certain SSPs can carry more weight than other SSPs in evaluating column performance and determining whether to replace a column. The importance of the SSPs in evaluating column performance can be ranked as provided in Table 1 below.

TABLE 1
Ranking of importance of SSPs in evaluating column performance

| Parameters | Importance in column evaluation |
|---|---|
| USP resolution | High |
| USP tailing | High |
| USP plate count | High |
| Asymmetry | Medium |
| Peak width | Medium |
| Peak height | Low |
| Elution time | Low |

The methods can comprise replacing the column or repacking the column stationary phase particles. The methods can comprise replacing the column or repacking the column stationary phase particles after about 500 runs, 600 runs, 700 runs, 800 runs, 900 runs, 1000 runs, 1100 runs, 1150 runs, 1200 runs, 1250 runs, 1300 runs, 1350 runs, 1400 runs, 1450 runs, or 1500 runs. The column can be replaced or repackaged after 500 to 1000 runs. The column can be replaced or repackaged after about 1000 runs.

### 2. Chromatography Column

The methods provided herein are applicable to media comprising silica-based and polymer-based particles, including those with chemically modified surfaces. The chromatography column can be used in chromatography methods such as size exclusion chromatography (SEC), reversed-phase liquid chromatography (RPLC), hydrophilic interaction liquid chromatography (HILIC), hydrophobic liquid chromatography (HIC), ion-exchange chromatography (IEX) (for example, anion exchange chromatography (AEX), cation exchange chromatography (CEX)), and affinity chromatography (AC).

Size exclusion chromatography (SEC) refers to a chromatographic method in which molecules in solution are separated by their size, and in some cases molecular weight. This method is usually applied to large molecules or macromolecular complexes such as proteins and industrial polymers. A typical SEC column's stationary phase comprises spherical beads having pores of certain sizes, and separation occurs when molecules of different sizes are included or excluded from the pores within the matrix. Small molecules can enter into the pores and therefore flow through the column is retarded, while large molecules do not enter the pores and elute in the column's void volume. Two common types of separations performed by SEC are fractionation and desalting. In desalting, the molecules of interest are larger than the size limit of the beads and is eluted in the void volume, while smaller molecules are retained in the pores. In fractionation, molecules of varying molecular weights are separated within the column's stationary phase.

Normal-phase chromatography is a method that historically uses unmodified silica alumina resins, and therefore the stationary phase packed in a chromatography column is hydrophilic in this method. The stationary phase particles can also be resins comprising polar organic moieties such as cyano and amino functional groups. Hydrophilic molecules in the mobile phase have a high affinity for the hydrophilic stationary phase and will adsorb to the column packing. Elution of the hydrophilic molecules adsorbed to the column packing requires the use of more hydrophilic or more polar solvents in the mobile phase to shift the molecules adsorbed to the stationary phase towards that of the mobile phase.

Reversed-phase chromatography (RPC), also called reversed-phase liquid chromatography (RPLC), is a method that uses a hydrophobic stationary phase to adsorb hydrophobic molecules from a polar (for example, aqueous) mobile phase and allow hydrophilic molecules to pass through first. A more hydrophobic solvent (for example, water miscible organic solvent) is then employed to elute the adsorbed molecules. Reversed-phase chromatography is essentially the reverse of normal-phase chromatography. Common types of resin for RPLC are particles (also termed “solid support”) covalently bonded to alkyl chains (such as octadecyl (C18), octyl (C8) and butyl (C4)), which form a hydrophobic surface to adsorb hydrophobic molecules.

Hydrophilic interaction liquid chromatography (HILIC) is method for separating polar compounds under high performance liquid chromatography mode. High performance liquid chromatography (HPLC), also known as high pressure liquid chromatography, is a technique that relies on pumps to pass a pressurized liquid solvent containing a sample mixture through a chromatography column filled with a solid stationary phase. Similar to normal-phase liquid chromatography, HILIC employs traditional polar stationary phases such as silica or resins carrying amino or cyano groups, but the mobile phase is usually water-miscible polar organic solvents, which is more similar to those employed in RPLC.

Hydrophobic liquid chromatography (HIC) is a chromatography technique which separates a mixture based on hydrophobicity but operates under a relatively mild conditions compared to RPLC. HIC stationary phase has weaker hydrophobic character than RPLC, and the decrease in polarity of the mobile phase to elute adsorbed analyte is by virtue of a decrease in salt concentration. HIC is generally applied in protein separations, as the milder mobile phase reduces the possibility of unfolding proteins and prevents loss of protein's biological activity.

Ion-exchange chromatography (IEX) is a method commonly used to separate ions and polar molecules. It is often applied to separate charged molecules, including proteins, nucleotides amino acids. The equilibrated stationary phase consists of an ionizable functional group where the molecules of interest in a mixture can bind while passing through the column. The bound molecules are then eluted using an eluant containing higher concentration of ions or changing pH of the column.

Anion-exchange and cation-exchange are two types of IEX. Cation-exchange chromatography is used when the molecules of interest are positively charged, which is enabled by a pH lower than the isoelectric point of the molecules; the stationary phase is negatively charged. Anion exchange is used when the molecules of interest are negatively charged, enabled by a pH higher than the molecules' isoelectric point; the stationary phase is positively charged.

Affinity chromatography (AC) is a method of separating a biomolecule from a mixture, based on a highly specific binding interaction between the biomolecules and another substance. The binding partner (also called “ligand”) of a biomolecules of interest in a mixture is immobilized to a solid stationary phase and capture the biomolecules of interest as the mobile phase moves through the column. A wash buffer is then applied to remove non-target biomolecules by disrupting their weaker interactions with the stationary phase, while the biomolecules of interest will remain bound. Target biomolecules may then be removed by applying an elution buffer, which disrupts interactions between the bound target biomolecules and the ligand.

The chromatography column is packed with a type of stationary phase particles selected from the group consisting of: anionic exchange chromatography stationary phase, cationic exchange chromatography stationary phase, affinity or pseudo-affinity chromatography stationary phase, hydrophilic interaction liquid chromatography stationary phase, hydrophobic liquid chromatography stationary phase, reversed-phase liquid chromatography stationary phase, and size exclusion chromatography stationary phase (or any combination thereof). The chromatography stationary phase can be multi-modal (for example, bi-modal) chromatography stationary phase (for example, a chromatography stationary phase that has anionic exchange and hydrophobic interaction groups, or a chromatography stationary phase that has both cation exchange and hydrophobic interaction groups).

The chromatography column particles are solid, insoluble particles modified with functional groups having properties appropriate for the intended chromatography method. The functional groups are covalently bonded to the solid particles. The functional groups are bound to the solid particles via non-covalent interactions.

The column particles make up the stationary phase matrix are selected from the group consisting of silica-based particles or polymers (for example, agarose, cellulose and polyacrylamide).

The column particles are modified with hydrophobic functional groups. The hydrophobic functional group is an alkyl chain, for example, octadecyl (C18), octyl (C8) and butyl (C4).

The column particles are modified with polar and hydrophilic functional groups. Polar functional groups that can be used to modify column particles are well-known in the art (see, for example, Buszewski and Noga, Anal Bioanal Chem (2012) 402(1):231-247). The hydrophilic functional group is DIOL, cyano, amino, carboxylic acid, alkylamide, amide, succinimide, polyethylene glycol, β-cyclodextrin, saccharides, dipeptide, zwitterionic, or sulfobetaine.

The column particles are modified with a ligand that specifically binds to the biomolecules of interest for use in affinity chromatography. Several the types of ligand-biomolecule interactions employed for affinity chromatography are well-known and commonly used in the field of chromatography. The ligand is a substrate or a substrate analogue for use in capturing enzymes. The ligand is an antibody or antigen-biding fragment for use in capturing an antigen. The ligand is an antigen for use in capturing an antibody or antigen-biding fragment. The ligand is lectin for use in capturing a polysaccharide. The ligand is a nucleic acid for use in capturing a complementary oligonucleotide. The ligand is hormone for use in capturing a receptor. The ligand is avidin for use in capturing biotin or a biotin-conjugated molecule. The ligand is calmodulin for use in capturing a calmodulin binding partner. The ligand is glutathione for use in capturing a GST fusion protein. The ligand protein A or protein G for use in capturing a immunoglobulins. The ligand comprises metal ions (for example, Ni) for use in capturing a tagged peptide (for example, His-tagged peptide).

### 3. Samples

The samples subjected to purification or analysis by column chromatography can comprise biomolecules (or biological molecules).

The molecule targeted for purification or analysis by column chromatography can be a biomolecule. A biomolecule can be a nucleic acid, peptide/polypeptide/protein, a carbohydrate and/or a lipid. The biomolecule can be a natural molecule. The biomolecule can be a synthetic molecule. The biomolecule can consist of one molecule unit. The biomolecule can be a complex consisting of multiple subunits.

The target biomolecule for purification or analysis by column chromatography can be a peptide, polypeptide or protein. Chromatography methods such as SEC, HILIC, IEX and affinity chromatography are often employed for purification of peptides, polypeptides and proteins because the mobile phase can be mild and does not denature the structure of the peptides, polypeptides and proteins, therefore preserving biological functions of the molecules.

The peptide, polypeptide or protein can be a therapeutic protein.

The peptide, polypeptide or protein can be an enzyme, a cytokine, a growth factor, a hormone, an interferon, an interleukin, or an anti-clotting factor.

The peptide, polypeptide or protein can be an antibody or an antigen binding fragment thereof. The antibody can be a polyclonal antibody, monoclonal antibody, a bispecific antibody, an Fab fragment, an F(ab′)2 fragment, a monospecific F(ab′)2 fragment, a bispecific F(ab′)2, a trispecific F(ab′)2, a monovalent antibody, an scFv fragment, a diabody, a bispecific diabody, a trispecific diabody, an scFv-Fc, a minibody, an IgNAR, a v-NAR, an hcIgG, or a vhH.

The peptide, polypeptide or protein can be a monomer. The peptide, polypeptide or protein can be a multimer, for example, dimer, trimer, teramer, and pentamer.

The peptide, polypeptide or protein can have a molecule weight of about 1-3000 kDa. The peptide, polypeptide or protein has a molecule weight of about 1-500 kDa. The peptide, polypeptide or protein as a molecule weight of about 1-10 kDa, 10-25 kDa, 25-45 kDa, 45-60 kDa, 60-75 kDa, 75-100 kDa. 100-125 kDa, 125-150 kDa., 150-175 kDa, 175-200 kDa, 200-225 kDa, 225-250 kDa, 250-300 kDa, 300-350 kDa, 350-400 kDa, 400-450 kDa or 45-500 kDa.

The target biomolecule purification or analysis by column chromatography can be a nucleic acid. The nucleic acid may be a polynucleotide, which is the polymeric form of nucleotides of any length, either ribonucleotides or deoxyribonucleotides and single-stranded or double-stranded. The target biomolecule can be DNA or RNA, genomic DNA, cDNA, DNA-RNA hybrids, or a polymer including purine and pyrimidine bases or other natural, chemically or biochemically modified, non-natural, or derivatized nucleotide bases. The target biomolecule can be an oligonucleotide, which is generally a polynucleotides of between about 5 and about 100 nucleotides of single- or double-stranded DNA. Oligonucleotides are also known as “oligomers” or “oligos” and may be isolated from genes, or chemically synthesized by methods known in the art.

### EXAMPLES

### Example 1: Study, Materials and Methods

Size exclusion chromatography (SEC) is a high throughput analytical method for quantifying the level of aggregates in solution. It separates the different oligomerization states of a monoclonal antibody (mAb) in a chromatography column under a constant flow rate in an isocratic environment. The column is typically packed with particles containing surface-distributed pores. These pores permit molecules with smaller hydrodynamic sizes to penetrate, while excluding larger ones. As the smaller molecules spend more time traveling through the pores, they are separated from the larger ones as the column is eluted. When molecules move through the non-particle area (i.e., void volume), their shape has a direct impact on the transport velocity. Molecules with a smaller frictional coefficient (e.g., sphere) move faster than the ones with a larger frictional coefficient (e.g., ellipsoid). Taken together, SEC enables separation of mAbs and any aggregates in solution based on their size and shape.

Silica-based particles are commonly used in SEC columns and the particles can be modified. Surface modification of the silica particle involves several chemical reactions to create covalent bonds between functional groups and the silanol groups on the silica surface. It has been reported that the efficiency of surface modification can vary resulting in unmodified and isolated silanol groups that can be potential liabilities. Due to the inherent fragility of large-pore particles and repeated exposure of various analytical conditions (e.g., changes in mobile phases, sample matrices, and pressure), the lifetime of a SEC column is usually limited to less than 500 injections (S. Fekete et al., Critical evaluation of fast size exclusion chromatographic separations of protein aggregates, applying sub-2 μm particles. J. Pharm. Biomed. Anal. 78-79 (2013) 141-149).

There have been limited reports monitoring SEC column performance with biological molecules. The studies described herein used an immunoglobulin G1 (IgG1) mAb (mAb-1) made in-house to study column aging and develop a robust method to monitor column performance.

### Materials

All chemicals used were analytical grade or sequencing grade quality. Sodium phosphate monobasic monohydrate (NaH₂PO₄·H₂O), sodium phosphate dibasic heptahydrate (Na₂HPO₄·7H₂O), and sodium chloride crystal (NaCl) were purchased from VWR International (Radnor, PA, USA). The water used in all experiments was purified by a Milli-Q Advantage A10 Water Purification System (Millipore, MA, USA). Regeneron-manufactured mAb-1, an IgG1 mAb, which was used for this study.

### Equipment and Columns

ACQUITY UPLC Protein BEH SEC column (200 Å, 1.7 μm, 4.6 mm×300 mm) and ACQUITY UPLC Protein BEH SEC Guard column (200 Å, 1.7 μm, 4.6 mm×30 mm) were purchased from Waters Corporation (Milford, MA, USA). Waters ACQUITY UPLC H-Class PLUS system (Waters; MA, USA) is used for SEC separations. Seven lots of SEC columns (total of 19 columns) and two UPLC H-class systems were evaluated throughout the study. New columns were equilibrated with at least 10 column volumes of mobile phase or until a steady backpressure was achieved.

### Procedures

The SEC mobile phase was composed of sodium phosphate buffer and sodium chloride at pH 7.0. Isocratic elution mode was applied at a constant flow rate of 0.3 mL/min and ambient column temperature (23±3° C.). Data were collected by UV absorbance at 280 nm. All samples had the injection volume of 0.2 μL. Each data set was collected from four consecutive injections and integrated automatically by Waters Empower 3 software without manual integration. The SSPs were acquired automatically from Waters Empower 3 software including USP resolution, USP plate count, USP tailing factor, asymmetry factor, retention time, peak height, peak area, % area, and peak width. JMP 15 software analyzed data and generated models; SSP equations are described in the Results and Discussion section.

### Example 2: Results and Discussion

### Experimental Design and Current Control Strategy

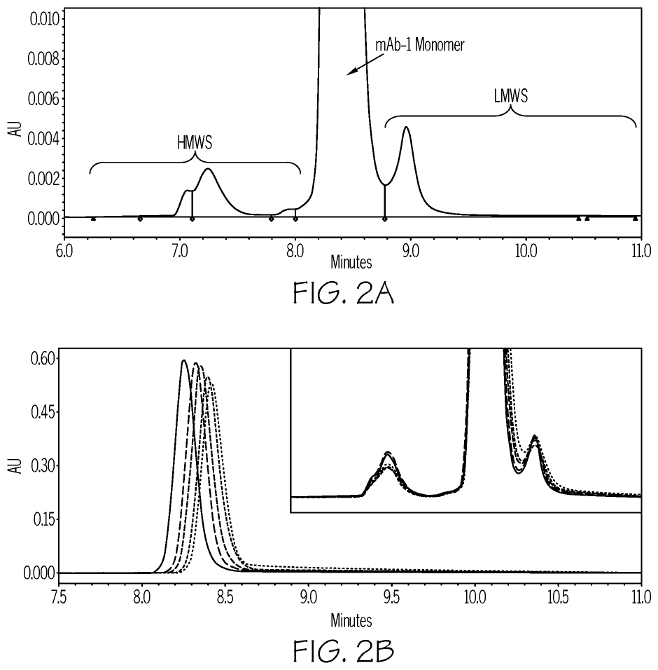

A sample of mAb-1 was loaded onto the SEC column with four repeated injections once per week, and resolution, tailing factor, plate count, asymmetry factor, peak width, peak height, peak area, % area, and elution time were monitored from the resultant chromatograms. All new columns used for this study were adjusted to the desired flow rate and equilibrated to ensure stable chromatographic conditions. Monomeric mAb-1 eluted between 8.0 and 8.8 minutes was used to analyze SSPs. Aggregates (i.e., high molecular weight species, HMWS) and fragments (i.e., low molecular weight species, LMWS) eluted between 6.5 and 8.0 minutes and between 8.6 and 11.0 minutes, respectively (FIG. 2A). After 1250 injections, SEC chromatograms showed deterioration in column performance, including changes in monomer peak shape and retention time and loss of resolution (FIG. 2B).

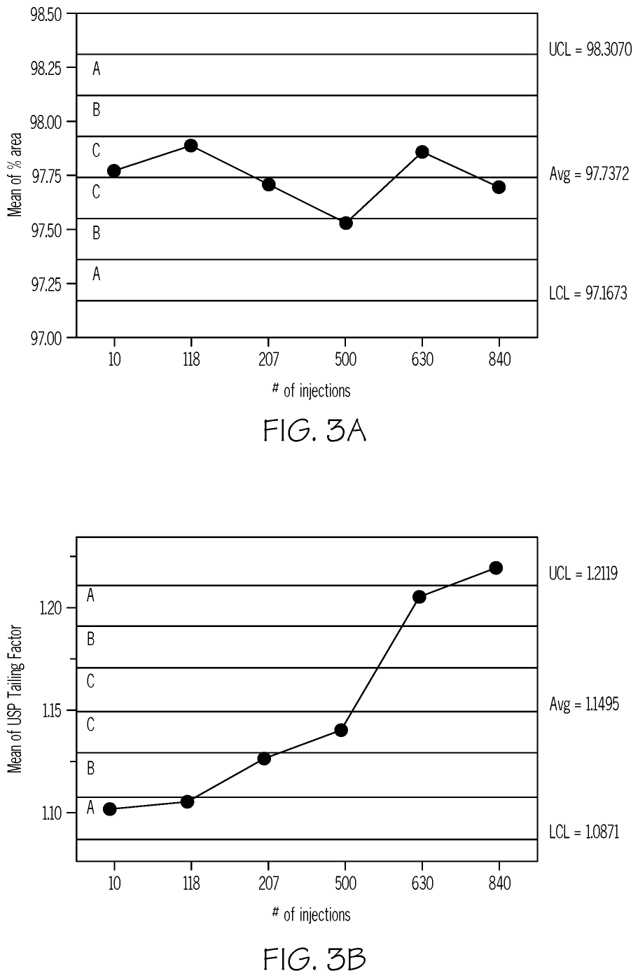

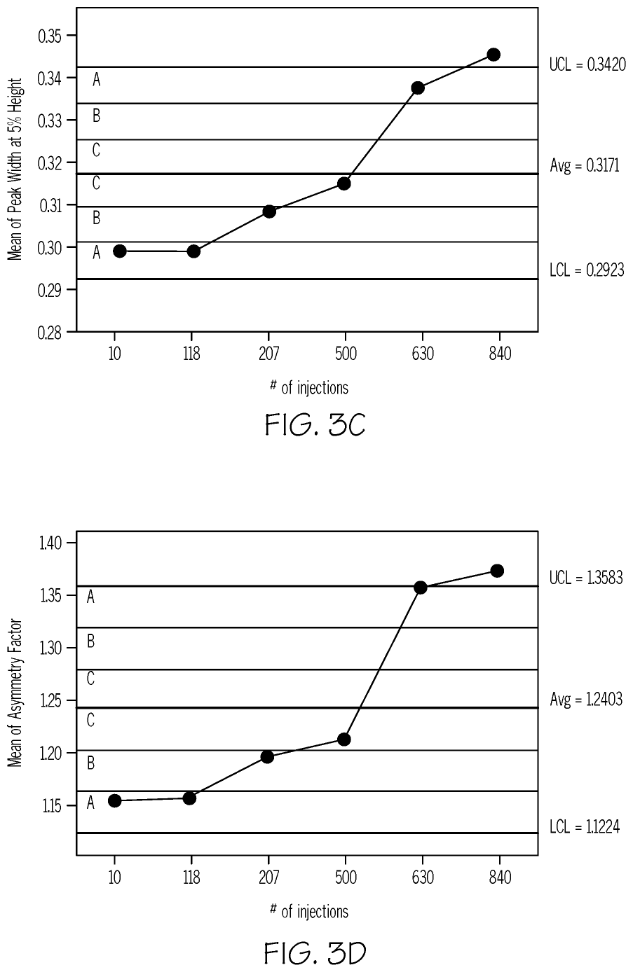

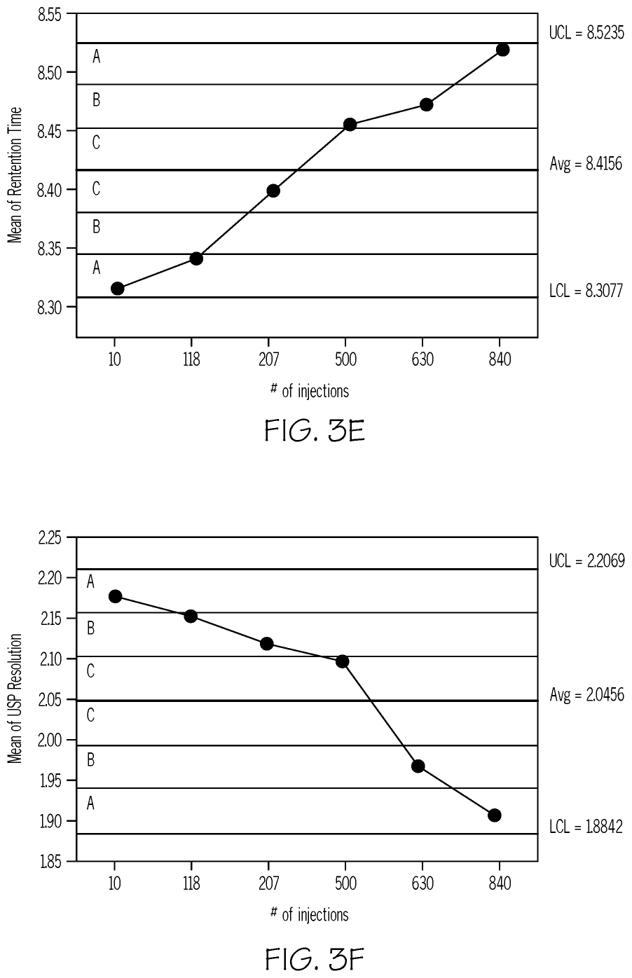

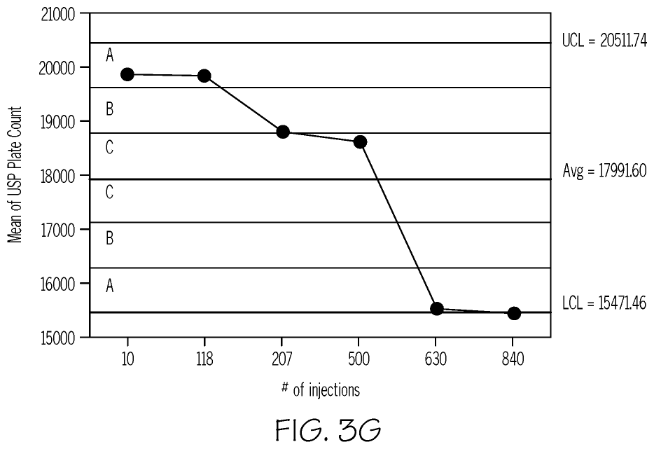

To evaluate how SSPs change over time, control charts for each SSP were generated using average values from the four repeated injections over time (FIGS. 3A-3G). Two thresholds, termed upper and lower control limits, were calculated from the average and the moving range between data subgroups. For routine maintenance of columns, monitoring the change in % area typically determines the performance of a column. Data that fall outside the control limits signify poor column performance and triggers the user to replace the SEC column. Although monitoring % area on a control chart is a good practice for tracking the performance of a column, it is less sensitive in detecting the gradual aging of columns.

Evaluation of data collected during this study indicate a control chart based on % area may provide a misleading interpretation of column performance. FIG. 3A shows that the average % area over time was 97.7%, with all data falling within +3 standard deviations from the mean and showing no trends, while other SSPs (e.g., resolution, tailing factor, plate count, asymmetry factor, peak width, and elution time) show data from each consecutive time point steadily increasing or decreasing over time, indicating column deterioration. The SSP window determined the range of control limits is a simple tool for determining the acceptable column performance criteria. In addition, routine monitoring of the indicators of column deterioration, such as the number of injections and operating conditions (e.g., pH, buffer, temperature, particulates, flow rate), may help identify the root causes of column aging.

### Correlation Between SSP and the Age of SEC Column

When monitoring the selected SSPs on the control charts, several parameters showed an apparent correlation with the age of the SEC column. For example, on a given column, the elution time of mAb-1 monomer consistently increased over time. To investigate this correlation, the nine monitored SSPs were plotted against the injection number for each SEC column. Of the nine SSPs, seven were found to have a linear correlation to the injection number, which is a measure of or proxy for column age. The coefficient of determination (R²) values for the seven SSPs that exhibited correlations were greater than 0.7. The analysis and implications of these SSPs are described below.

### Retention Time

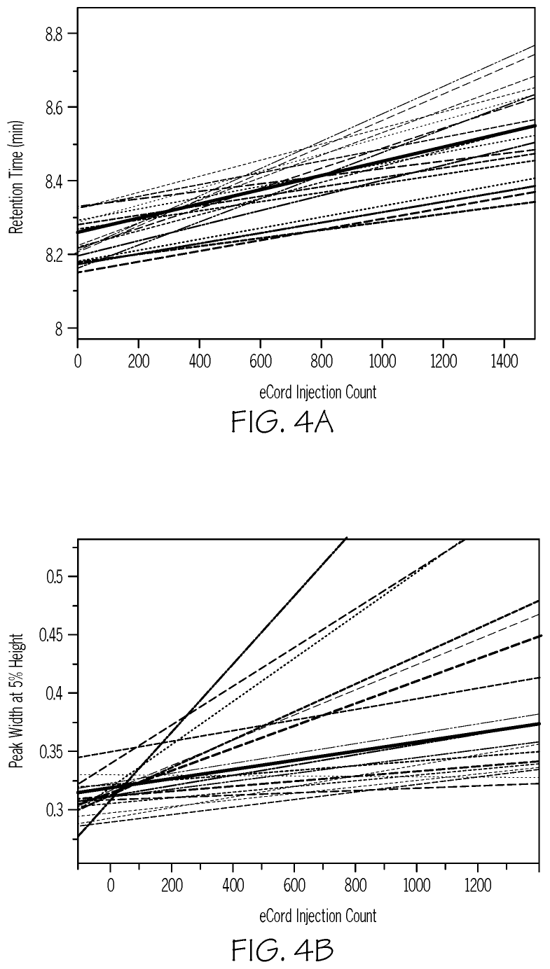

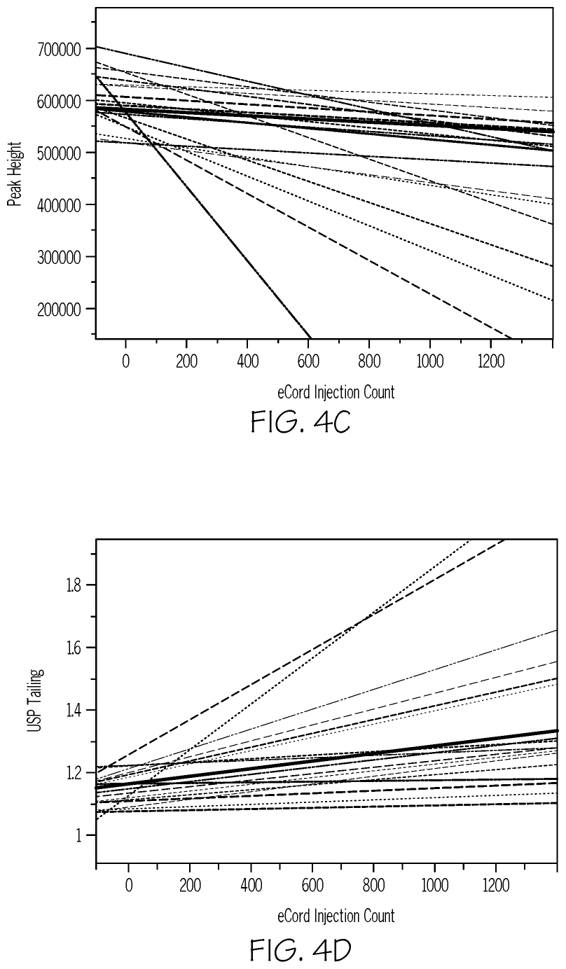

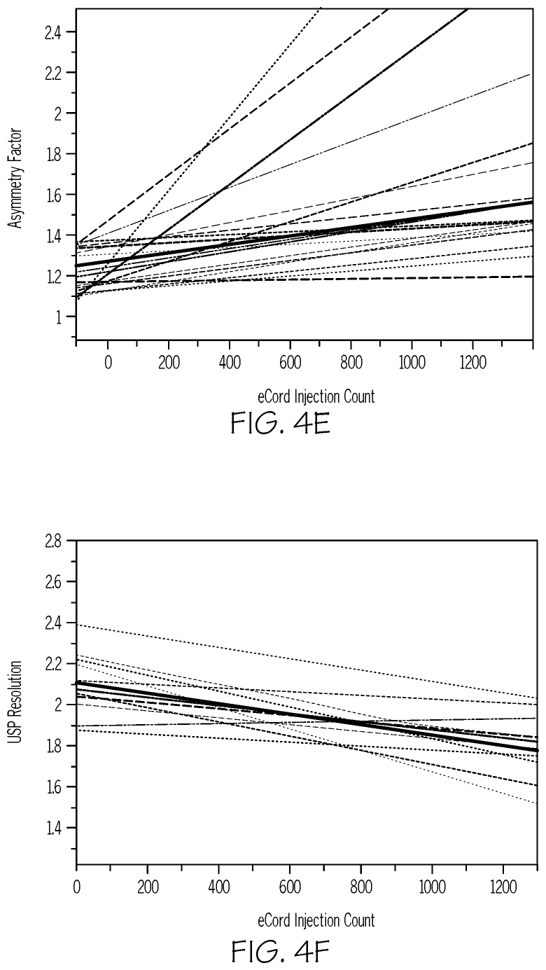

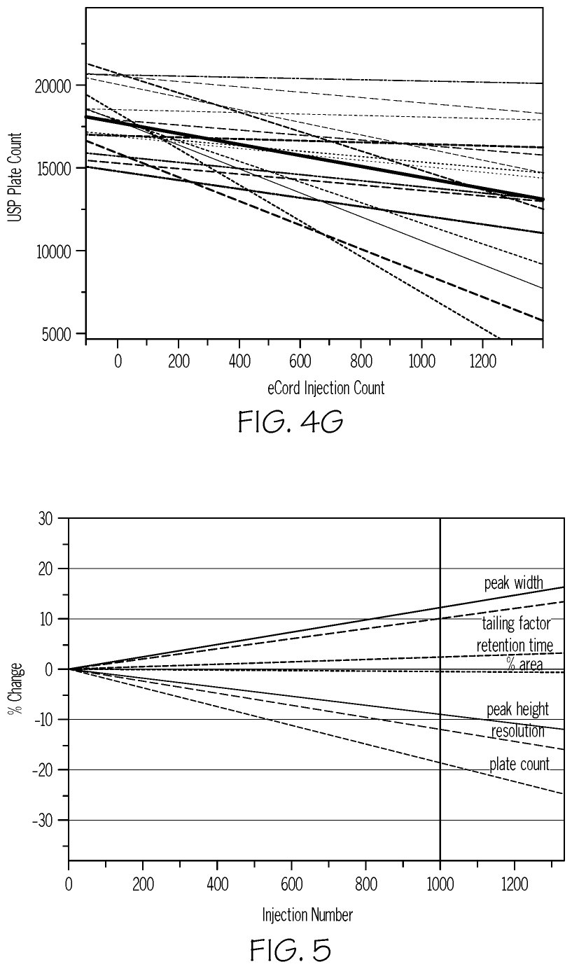

Retention time is a measurement of the time required for a molecule to pass through the separation system, from injection to detection. This simple and easily measured SSP tracks the column consistency of each analysis run. Small shifts in retention time are not unexpected and often are attributable to slight variations in mobile phase composition or instrument setup. However, a constant, increasing trend in retention time over time suggests column deterioration. In FIG. 4A, the monomer peak shifts to a later retention time as the number of injections on the column increases, likely due to increased interaction between the eluting molecule and the column stationary phase. A strongly positive linear correlation between retention time and injection number was observed.

### Peak Width and Peak Height

As a column ages, the functional group or the silica-containing core of the stationary phase may degrade, increasing the level of nonspecific interaction with eluting molecules. This degradation can alter the peak tailing and overall peak width of a given peak. In this study, we monitored the monomer peak width at 5% peak height for mAb-1. FIG. 4B shows that the overall peak width increased with the number of injections. Peak height is the distance from the baseline of a peak to its apex. FIG. 4C shows that peak height exhibits a negative linear relationship to column injection number. At a constant injection column load, the changes of peak height can be ascribed to broadened peak and unsymmetrical shape shown in FIG. 2B.

### Tailing Factor

The tailing factor is the measurement of peak tailing with USP tailing factor (T_{f}) expressed in Equation 1:

$${T}_{f} = \frac{a + b}{2 a} \qquad Equation 1$$

where a and b are the first and the second half-width at 5% of the maximum peak height of the target peak, respectively.

An ideal chromatographic peak on a new column has a Gaussian distribution with b slightly larger than a. As the column ages, the peak is typically broadened at the tail end due to increased interaction between the eluting molecule and the column stationary phase, resulting in an increased T_{f}. Indeed, we observed such an increase in tailing on the monomer peak of mAb-1, with a positive, linear correlation between T_{f} and the number of injections (FIG. 4D).

### Asymmetry Factor

Similar to tailing factor, asymmetry factor is a common measure of peak distortion. Asymmetry factor (As) can be used to evaluate peak tailing and peak fronting as an indicator of the loss of column quality, and is defined in Equation 2:

$${A}_{s} = \frac{b}{a} \qquad Equation 2$$

where a and b are the first and the second half-width at 10% of the maximum peak height of the target peak, respectively.

As a result, an aged column that causes peak tailing has Aₛ greater than 1, whereas that causing peak fronting has Aₛ less than 1. Consistent with the trend of tailing factor, Aₛ for mAb-1 monomer gradually increased with the injection numbers (FIG. 4E).

### Resolution

Resolution is the measurement for differentiating two eluting peaks based on their retention times and peak widths in a chromatogram. USP resolution (Rₛ) was applied in this study and is defined in Equation 3:

$${R}_{s} = \frac{2 ( R {t}_{2} - R {t}_{1} )}{( {W}_{2} + {W}_{1} )} \qquad Equation 3$$

where Rt₂ and Rt₁ are the retention time for LMWS and monomer peaks of mAb-1, respectively, and W₂ and W₁ are the peak widths at the baseline between tangent lines drawn at 50% of mAb-1 LMWS and monomer peak height, respectively.

FIG. 4F shows that the USP resolution decreased with an increasing number of injections, suggesting that the quality of separation between monomer and LMWS of mAb-1 is reduced as the column ages.

### Plate Count

Plate count is considered a critical indicator of column efficiency. USP plate count (N) was applied in this study and is defined in Equation 4:

$$N = 16 {( \frac{R t}{W} )}^{2} \qquad Equation 4$$

where Rt is the retention time for monomer and W is the tangent width of the monomer peak at baseline.

The USP plate count (FIG. 4G) showed decreasing trends across most columns as the injection count increased. Generally, the lower the plate count of a column, the less efficient for separation.

In this section, we discussed the linear trends between SSPs and number of injections across several columns. However, in the analysis of these relationships, each column exhibited a unique slope and y-intercept. Therefore, for the purpose of accelerating the analysis period and applying it to the routine evaluation process, a statistical model is needed to summarize intercept and slope from all columns. If this model is established, it can efficiently categorize SSPs into column performance screening and long-term control monitoring.

### Example 3: Evaluation of Column Performance Via Statistically Defined SSPS

In this study, 19 SEC columns were evaluated over 48 weeks. Each column is represented by a dashed or dotted line in FIGS. 4A-4G.

Seven SSPs (resolution, tailing factor, plate count, asymmetry factor, peak width, peak height, and elution time) were tracked and it was determined that the SSPs are highly correlated to the injection numbers, which can be indicators for estimating column performance and lifetime. Generalized linear models (GLM) were applied to analyze these SSPs collected from multiple columns. Instead of continuously injecting the same sample on one column, multiple studies were performed to assess the impact of column lot-to-lot variability and provide more general conclusions on column lifetime. The proposed model is:

$$\hat{y} = {β}_{0} + {β}_{1} {x}_{1} + {β}_{2} {x}_{2}$$

where ŷ is the estimated SSP responses and x₁ and x₂ are injection number and grouped column lots, respectively. β₀ is the estimated average intercept, and β₁ and β₂ are regression coefficients that are computed to minimize residual sum of squares. In this case, β₀ can be interpreted as the average initial conditions for SSPs of a selected column, which is determined by its manufacturing process. The rate of column deterioration can be described based on the slopes from this equation (i.e., % change per injections). Lower and upper bounds from 95% confidence intervals were given on both intercept and slope of the SSPs to maintain an acceptable range for columns. Both independent variables yield a statistically significant effect on the SSPs (p<0.0001).

Four models reveal increasing trends (depicted by the solid lines) in four SSPs, including elution time, peak width, asymmetry factor, and tailing factor (FIGS. 4A, 4B, 4D, 4E). As the column ages, the stationary phase may lose functional groups, increasing the risk of exposing mAb-1 to silanol groups on the particle surface, and thus increasing nonspecific interactions between the stationary phase and eluting molecules. The net result is that molecules move more slowly through the stationary phase, resulting in a longer elution time. Furthermore, tailing and width widening of a peak occur when the undesired interactions take place, which make integration and quantification more difficult. As expected, increased injection numbers lead to increased elution time, tailing factor, asymmetry factor and peak width. In Table 1, injection number and grouped column lots explained 94%, 81%, 83%, and 79% of the variance in retention time, peak width (at 5%), tailing factor, and asymmetry factor, respectively.

TABLE 2
Common intercept and common slope of the general
linear model with a 95% confidence interval and
R-squared for the predicted versus actual column
performance. P-value is < 0.0001 for each parameter

| System | | | |
|---|---|---|---|
| Suitability | β0 with 95% CI | β1 with 95% CI | |
| Parameters | [lower bound, | [lower bound, | |
| (SSPs) | upper bound] | upper bound] | R² |
| Resolution (USP) | 2.107 | −0.000255 | 0.89 |
| | [2.089, 2.126] | [−0.000286, −0.000224] | |
| Tailing Factor | 1.166 | 0.000118 | 0.83 |
| (USP) | [1.1577, 1.1743] | [0.0001, 0.00013] | |
| Plate Count (USP) | 17757 | −3.29 | 0.77 |
| | [17467, 18046] | [−3.79, −2.78] | |
| Asymmetry | 1.27 | 0.0002 | 0.79 |
| Factor | [1.25, 1.29] | [0.00017, 0.00023] | |
| Peak Width at 5% | 0.32 | 0.000039 | 0.81 |
| | [0.317, 0.323] | [0.000031, 0.000044] | |
| Retention Time | 8.23 | 0.00019 | 0.94 |
| | [8.209, 8.221] | [0.00018, 0.0002] | |
| Peak Height | 577570 | −56.43 | 0.77 |
| | [571415, 583724] | [−68.18, −44.67] | |

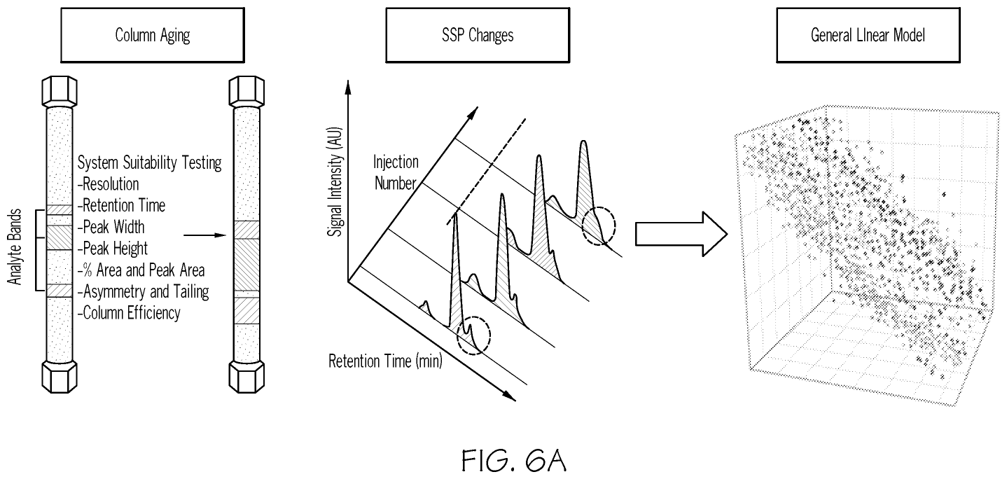

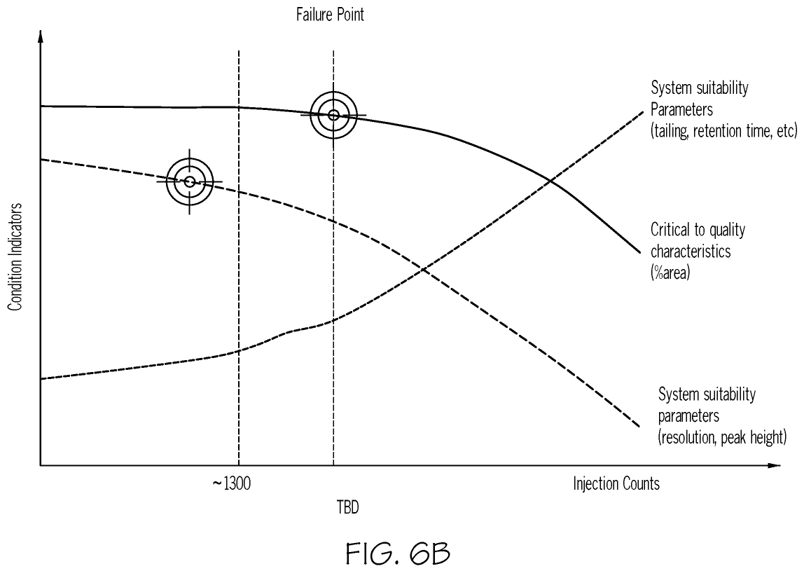

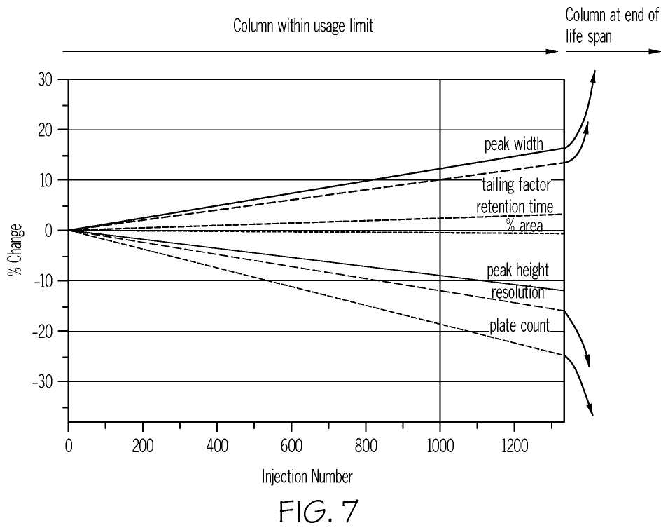

Based on the collected data in the GLM, mAb-1 elutes at approximate 8.2 minutes with a tailing factor of 1.17 and an asymmetry factor of 1.27 at the beginning of column life. It is worth noting that a perfectly symmetrical peak shape is rarely seen, and some degree of peak asymmetry is generally considered acceptable (e.g., tailing factor <1.3 and asymmetry factor <1.2). The rate of change (slope) in a tailing factor is 10.2% per 1000 injections (FIG. 5), which implies that a new column with initial tailing factor 1.16 is assumed to reach a value of 1.3 at approximate 1100 injections based on the model. Retention time and peak width are expected to increase by 2.3% and 12.2%, respectively, when a column reaches 1000 injections (See FIGS. 4A, 4B and 5).

In contrast to the four SSP parameters mentioned in the previous paragraph, peak height, resolution, and plate count show decreased trends with the aging of the column (FIGS. 4C, 4F, 4G). As the column ages, the resolution between the monomer peak and the LMWS peak decreases, which may ultimately result in incorrect peak integration. The linear regression analysis indicated an average of 11.3% reduction in resolution per 1000 injection on the SEC column (FIG. 5). Considering the change in retention time is negligible (˜1 s/1000 injections), the decrease in plate count can be mainly attributed to the increase in peak width. As a result, the plate count (Table 1) shows decreasing trends across most of the columns evaluated, with an average of 19.2% decrease per 1000 injections from the linear regression analysis (FIG. 5). The decrease in plate count suggests the peak broadening is caused by reduced column efficiency.

TABLE 3
Percent change of SSP parameters after 500 injections

| | | | | | % Change at 500 |
|---|---|---|---|---|---|
| Parameter | | Equation (Y = b + mX) | Intercept 95% CI | Slope 95% CI | Inj # [95% CI]* |
| (Y) | R² | X = injection counts | [lower, upper] | [lower, upper] | [lower, upper] |
| USP | 0.89 | Y = 2.0993^{†} − 0.00022X | [2.0807, 2.1178] | [−0.00025, −0.000197] | 5.23% [4.69−5.95] |
| resolution | | | | | |
| USP tailing | 0.83 | Y = 1.166^{†} + 0.0001184X | [1.1743, 1.1577] | [0.0001, 0.00013] | 5.07% [4.28−5.57] |
| Asymmetry | 0.79 | Y = 1.2702^{†} + 0.0002X | [1.2539, 1.2864] | [0.00017, 0.00023] | 7.87% [6.69, 9.05] |
| @10% | | | | | |
| Elution | 0.94 | Y = 8.2149^{†} + 0.00019X | [8.2092, 8.2206] | [0.00018, 0.0002] | 1.15% [1.09, 1.21] |
| time | | | | | |
| Peak | 0.81 | Y = 0.3198^{†} + 0.000039X | [0.3172, 0.3225] | [0.000031, 0.000044] | 6.09% [4.8, 6.8] |
| width@5% | | | | | |
| Peak height | 0.77 | Y = 577570^{†} − 56.4304X | [571415, 583724] | [−44.67, −68.18] | 4.88% [3.8, 5.9] |
| USP plate | 0.77 | Y = 17757^{†} − 3.2879X | [17467, 18046] | [−3.79, −2.78] | 9.25% [7.8, 10.67] |
| count | | | | | |

*Percent change is shown as absolute value.

TABLE 4
Percent change of USP resolution
according to number of injections

| | X | | | | |
|---|---|---|---|---|---|
| | (injection | | | | % |
| | count) | Intercept | Slope | y | change |
| USP | 1 | 2.0993 | −0.00022 | 2.09908 | −0.01 |
| resolution | 100 | 2.0993 | −0.00022 | 2.0773 | −1.05 |
| | 300 | 2.0993 | −0.00022 | 2.0333 | −3.14 |
| | 500 | 2.0993 | −0.00022 | 1.9893 | −5.24 |
| | 700 | 2.0993 | −0.00022 | 1.9453 | −7.34 |
| | 1000 | 2.0993 | −0.00022 | 1.8793 | −10.48 |
| | 1200 | 2.0993 | −0.00022 | 1.8353 | −12.58 |

TABLE 5
Percent change of USP tailing according to number of injections

| | X | | | | |
|---|---|---|---|---|---|
| | (injection | | | | % |
| | count) | Intercept | Slope | y | change |
| USP | 1 | 1.166 | 0.000118 | 1.166118 | 0.01 |
| tailing | 100 | 1.166 | 0.000118 | 1.17784 | 1.02 |
| | 300 | 1.166 | 0.000118 | 1.20152 | 3.05 |
| | 500 | 1.166 | 0.000118 | 1.2252 | 5.08 |
| | 700 | 1.166 | 0.000118 | 1.24888 | 7.11 |
| | 1000 | 1.166 | 0.000118 | 1.2844 | 10.15 |
| | 1200 | 1.166 | 0.000118 | 1.30808 | 12.19 |

TABLE 6
Percent change of asymmetry according to number of injections

| | X | | | | |
|---|---|---|---|---|---|
| | (injection | | | | % |
| | count) | Intercept | Slope | y | change |
| Asymmetry | 1 | 1.2702 | 0.0002 | 1.2704 | 0.02 |
| at 10% | 100 | 1.2702 | 0.0002 | 1.2902 | 1.57 |
| peak | 300 | 1.2702 | 0.0002 | 1.3302 | 4.72 |
| height | 500 | 1.2702 | 0.0002 | 1.3702 | 7.87 |
| | 700 | 1.2702 | 0.0002 | 1.4102 | 11.02 |
| | 1000 | 1.2702 | 0.0002 | 1.4702 | 15.75 |
| | 1200 | 1.2702 | 0.0002 | 1.5102 | 18.89 |

TABLE 7
Percent change of elution time according to number of injections

| | X | | | | |
|---|---|---|---|---|---|
| | (injection | | | | % |
| | count) | Intercept | Slope | y | change |
| Elution | 1 | 8.2149 | 0.00019 | 8.21509 | 0.00 |
| time | 100 | 8.2149 | 0.00019 | 8.2339 | 0.23 |
| | 300 | 8.2149 | 0.00019 | 8.2719 | 0.69 |
| | 500 | 8.2149 | 0.00019 | 8.3099 | 1.16 |
| | 700 | 8.2149 | 0.00019 | 8.3479 | 1.62 |
| | 1000 | 8.2149 | 0.00019 | 8.4049 | 2.31 |
| | 1200 | 8.2149 | 0.00019 | 8.4429 | 2.78 |

TABLE 8
Percent change of peak width according to number of injections

| | X | | | | |
|---|---|---|---|---|---|
| | (injection | | | | % |
| | count) | Intercept | Slope | y | change |
| Peak width | 1 | 0.3198 | 0.000039 | 0.319839 | 0.01 |
| at 5% peak | 100 | 0.3198 | 0.000039 | 0.3237 | 1.22 |
| height | 300 | 0.3198 | 0.000039 | 0.3315 | 3.66 |
| | 500 | 0.3198 | 0.000039 | 0.3393 | 6.10 |
| | 700 | 0.3198 | 0.000039 | 0.3471 | 8.54 |
| | 1000 | 0.3198 | 0.000039 | 0.3588 | 12.20 |
| | 1200 | 0.3198 | 0.000039 | 0.3666 | 14.63 |

TABLE 9
Percent change of peak height according to number of injections

| | X | | | | |
|---|---|---|---|---|---|
| | (injection | | | | % |
| | count) | Intercept | Slope | y | change |
| Peak | 1 | 577570 | −56.4304 | 577513.6 | −0.01 |
| height | 100 | 577570 | −56.4304 | 571927 | −0.98 |
| | 300 | 577570 | −56.4304 | 560640.9 | −2.93 |
| | 500 | 577570 | −56.4304 | 549354.8 | −4.89 |
| | 700 | 577570 | −56.4304 | 538068.7 | −6.84 |
| | 1000 | 577570 | −56.4304 | 521139.6 | −9.77 |
| | 1200 | 577570 | −56.4304 | 509853.5 | −11.72 |

TABLE 10
Percent change of USP plate count
according to number of injections

| | X | | | | |
|---|---|---|---|---|---|
| | (injection | | | | % |
| | count) | Intercept | Slope | y | change |
| USP plate | 1 | 17757 | −3.2879 | 17753.71 | −0.02 |
| count | 100 | 17757 | −3.2879 | 17428.21 | −1.85 |
| | 300 | 17757 | −3.2879 | 16770.63 | −5.55 |
| | 500 | 17757 | −3.2879 | 16113.05 | −9.26 |
| | 700 | 17757 | −3.2879 | 15455.47 | −12.96 |
| | 1000 | 17757 | −3.2879 | 14469.1 | −18.52 |
| | 1200 | 17757 | −3.2879 | 13811.52 | −22.22 |

### Example 4: Biologics Production

Careful examination of SSPs before and throughout routine analysis using control charts and general linear models revealed that SSPs are critical tools to detect column aging. Monitoring the changes in SSPs over time helps to establish realistic and historical data-based acceptance criteria to determine when a column should be replaced. Another approach is utilizing the percent change and the estimated intercept obtained from the linear regression between SSPs and injection number to predict how fast a column is aging or to screen and assess the initial performance of a new column. Replicate injections of in-house test standards on multiple columns and the establishment of long-term, internal control criteria for SSPs ensure consistent analytical results and will lead to faster identification of column failures and higher data quality.

The methods described above can be used to monitor the performance of columns for production of a range of biologic products including, but are not limited to, protein-based therapeutics (for example, monoclonal antibody-based therapeutics and receptor Fc fusion proteins), oligonucleotide-based therapeutics (for example, antisense, small interfering RNA, aptamer); carbohydrate-based therapeutics (for example, heparin) and lipid-based drug delivery products.

Protein-based therapeutics include, but are not limited to, the production of biological and pharmaceutical products. Protein-based therapeutics can have any amino acid sequence, and include any protein, polypeptide, or peptide that is desired to be manufactured. Included are, but not limited to, viral proteins, bacterial proteins, fungal proteins, plant proteins and animal (including human) proteins. Protein types can include, but are not limited to, antibodies, receptors, Fc-containing proteins, trap proteins, enzymes, factors, repressors, activators, ligands, reporter proteins, selection proteins, protein hormones, protein toxins, structural proteins, storage proteins, transport proteins, neurotransmitters and contractile proteins. Derivatives, components, chains and fragments of the above also are included. The sequences can be natural, semi-synthetic or synthetic.

Nucleic acid and nuclease therapeutics, such as RNAi, siRNA and CRISPER/Cas9, also are biologic therapeutics. Cemdisiran, a C5 siRNA therapeutic; ALN-APP, an RNAi for early onset Alzheimer's disease, an RNAi for nonalcoholic steatohepatitis and CRISPR/Cas9 for transthyretin amyloidosis are included.

For example, for antibody production, the inventions are amendable for research and production use for diagnostics and therapeutics based upon all major antibody classes, namely IgG, IgA, IgM, IgD and IgE. IgG is a preferred class, such as IgG1 (including IgG1λ and IgG1κ), IgG2, IgG3, IgG4 and others. Further examples of antibody include a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. The antibody can be an IgG1 antibody. The antibody can be an IgG2 antibody. The antibody can be an IgG4 antibody. The antibody can be a chimeric IgG2/IgG4 antibody. The antibody can be a chimeric IgG2/IgG1 antibody. The antibody can be a chimeric IgG2/IgG1/IgG4 antibody. Derivatives, components, domains, chains and fragments of the above also are included. Further examples of antibody include a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. The antibody can be an IgG1 antibody. The antibody can be an IgG2 antibody. The antibody can be an IgG4 antibody. The antibody can be a chimeric IgG2/IgG4 antibody. The antibody can be a chimeric IgG2/IgG1 antibody. The antibody can be a chimeric IgG2/IgG1/IgG4 antibody.

The antibody can be selected from the group consisting of an anti-Programmed Cell Death 1 antibody (e.g. an anti-PD1 antibody as described in U.S. Pat. Appln. Pub. No. US2015/0203579A1), an anti-Programmed Cell Death Ligand-1 (e.g. an anti-PD-L1 antibody as described in in U.S. Pat. Appln. Pub. No. US2015/0203580A1), an anti-Dll4 antibody, an anti-Angiopoetin-2 antibody (e.g. an anti-ANG2 antibody as described in U.S. Pat. No. 9,402,898), an anti-Angiopoetin-Like 3 antibody (e.g. an antiAngPtl3 antibody as described in U.S. Pat. No. 9,018,356), an anti-platelet derived growth factor receptor antibody (e.g. an anti-PDGFR antibody as described in U.S. Pat. No. 9,265,827), an anti-Erb3 antibody, an anti-Prolactin Receptor antibody (e.g. anti-PRLR antibody as described in U.S. Pat. No. 9,302,015), an anti-Complement 5 antibody (e.g. an 25 anti-C5 antibody as described in U.S. Pat. Appln. Pub. No US2015/0313194A1), an anti-TNF antibody, an anti-epidermal growth factor receptor antibody (e.g. an anti-EGFR antibody as described in U.S. Pat. No. 9,132,192 or an anti-EGFRvIII antibody as described in U.S. Pat. Appln. Pub. No. US2015/0259423A1), an anti-Proprotein Convertase Subtilisin Kexin-9 antibody (e.g. an anti-PCSK9 antibody as described in U.S. Pat. No. 8,062,640 or U.S. Pat. Appln. Pub. No. US2014/0044730A1), an anti-Growth And Differentiation Factor-8 antibody (e.g. an anti-GDF8 antibody, also known as anti-myostatin antibody, as described in U.S. Pat. No. 8,871,209 or 9,260,515), an anti-Glucagon Receptor (e.g. anti-GCGR antibody as described in U.S. Pat. Appln. Pub. Nos. US2015/0337045A1 or US2016/0075778A1), an anti-VEGF antibody, an anti-IL1R antibody, an interleukin 4 receptor antibody (e.g. an antiIL4R antibody as described in U.S. Pat. Appln. Pub. No. US2014/0271681A1 or U.S. Pat. No. 8,735,095 or 8,945,559), an anti-interleukin 6 receptor antibody (e.g. an anti-IL6R antibody as described in U.S. Pat. Nos. 7,582,298, 8,043,617 or 9,173,880), an anti-IL1 antibody, an anti-IL2 antibody, an anti-IL3 antibody, an anti-IL4 antibody, an anti-IL5 antibody, an anti-IL6 antibody, an anti-IL7 antibody, an anti-interleukin 33 (e.g. anti-IL33 antibody as described in U.S. Pat. Appln. Pub. Nos. US2014/0271658A1 or US2014/0271642A1), an anti-Respiratory syncytial virus antibody (e.g. anti-RSV antibody as described in U.S. Pat. Appln. Pub. No. US2014/0271653A1), an anti-Cluster of differentiation 3 (e.g. an anti-CD3 antibody, as described in U.S. Pat. Appln. Pub. Nos. US2014/0088295A1 and US20150266966A1, and in U.S. Application No. 62/222,605), an anti-Cluster of differentiation 20 (e.g. an anti-CD20 antibody as described in U.S. Pat. Appln. Pub. Nos. US2014/0088295A1 and US20150266966A1, and in U.S. Pat. No. 7,879,984), an anti-CD19 antibody, an anti-CD28 antibody, an anti-Cluster of Differentiation 48 (e.g. anti-CD48 antibody as described in U.S. Pat. No. 9,228,014), an anti-Fel d1 antibody (e.g. as described in U.S. Pat. No. 9,079,948), an anti-Middle East Respiratory Syndrome virus (e.g. an anti-MERS antibody as described in U.S. Pat. Appln. Pub. No. US2015/0337029A1), an anti-Ebola virus antibody (e.g. as described in U.S. Pat. Appln. Pub. No. US2016/0215040), an anti-Zika virus antibody, an anti-Lymphocyte Activation Gene 3 antibody (e.g. an anti-LAG3 antibody, or an anti-CD223 antibody), an anti-Nerve Growth Factor antibody (e.g. an anti-NGF antibody as described in U.S. Pat. Appln. Pub. No. US2016/0017029 and U.S. Pat. Nos. 8,309,088 and 9,353,176) and an anti-Activin A antibody. The bispecific antibody is selected from the group consisting of an anti-CD3×anti-CD20 bispecific antibody (as described in U.S. Pat. Appln. Pub. Nos. US2014/0088295A1 and US20150266966A1), an anti-CD3×anti-Mucin 16 bispecific antibody (e.g., an anti-CD3×anti-Muc16 bispecific antibody), and an anti-CD3×anti-Prostate-specific membrane antigen bispecific antibody (e.g., an anti-CD3×anti-PSMA bispecific antibody). See also U.S. Patent Publication No. US 2019/0285580 A1. Also included are a Met×Met antibody, an agonist antibody to NPR1, an LEPR agonist antibody, a BCMA×CD3 antibody, a MUC16×CD28 antibody, a GITR antibody, an IL-2Rg antibody, an EGFR×CD28 antibody, a Factor XI antibody, antibodies against SARS-CoC-2 variants, a Fel d 1 multi-antibody therapy, a Bet v 1 multi-antibody therapy. Derivatives, components, domains, chains and fragments of the above also are included.

Exemplary antibodies to be produced according to the inventions include Alirocumab, Atoltivimab, Maftivimab, Odesivimab, Odesivivmab-ebgn, Casirivimab, Imdevimab, Cemiplimab, Cemplimab-rwlc, Dupilumab, Evinacumab, Evinacumab-dgnb, Fasinumab, Fianlimab, Garetosmab, Itepekimab Nesvacumab, Odrononextamab, Pozelimab, Sarilumab, Trevogrumab, and Rinucumab.

Additional exemplary antibodies include Ravulizumab-cwvz, Abciximab, Adalimumab, Adalimumab-atto, Ado-trastuzumab, Alemtuzumab, Atezolizumab, Avelumab, Basiliximab, Belimumab, Benralizumab, Bevacizumab, Bezlotoxumab, Blinatumomab, Brentuximab vedotin, Brodalumab, Canakinumab, Capromab pendetide, Certolizumab pegol, Cetuximab, Denosumab, Dinutuximab, Durvalumab, Eculizumab, Elotuzumab, Emicizumab-kxwh, Emtansine alirocumab, Evolocumab, Golimumab, Guselkumab, Ibritumomab tiuxetan, Idarucizumab, Infliximab, Infliximab-abda, Infliximab-dyyb, Ipilimumab, Ixckizumab, Mepolizumab, Necitumumab, Nivolumab, Obiltoxaximab, Obinutuzumab, Ocrelizumab, Ofatumumab, Olaratumab, Omalizumab, Panitumumab, Pembrolizumab, Pertuzumab, Ramucirumab, Ranibizumab, Raxibacumab, Reslizumab, Rinucumab, Rituximab, Secukinumab, Siltuximab, Tocilizumab, Trastuzumab, Ustekinumab, and Vedolizumab.

The inventions also are amenable to the production of other molecules, including fusion proteins. Preferred fusion proteins include Receptor-Fc-fusion proteins, such as certain Trap proteins. The protein of interest can be a recombinant protein that contains an Fc moiety and another domain, (e.g., an Fc-fusion protein). An Fc-fusion protein can be a receptor Fc-fusion protein, which contains one or more extracellular domain(s) of a receptor coupled to an Fc moiety. The Fc moiety comprises a hinge region followed by a CH2 and CH3 domain of an IgG. The receptor Fc-fusion protein contains two or more distinct receptor chains that bind to either a single ligand or multiple ligands. For example, an Fc-fusion protein is a TRAP protein, such as for example an IL-1 trap (e.g., rilonacept, which contains the IL-1RAcP ligand binding region fused to the Il-1R1 extracellular region fused to Fc of hIgG1; see U.S. Pat. No. 6,927,044, or a VEGF trap (e.g., aflibercept or ziv-aflibercept, which contains the Ig domain 2 of the VEGF receptor Flt1 fused to the Ig domain 3 of the VEGF receptor Flk1 fused to Fc of hIgG1; see U.S. Pat. Nos. 7,087,411 and 7,279,159). An Fc-fusion protein can also be a ScFv-Fc-fusion protein, which contains one or more of one or more antigen binding domain(s), such as a variable heavy chain fragment and a variable light chain fragment, of an antibody coupled to an Fc moiety. Derivatives, components, domains, chains and fragments of the above also are included.

Other proteins lacking Fc portions, such as recombinantly produced enzymes and mini-traps, also can be made according to the inventions. Mini-traps are trap proteins that use a multimerizing component (MC) instead of an Fc portion, and are disclosed in U.S. Pat. Nos. 7,279,159 and 7,087,411. Derivatives, components, domains, chains and fragments of the above also are included.

The inventions can also be employed in the production of recombinantly-produced proteins, such as viral proteins (for example, adenovirus and adeno-associated virus (AAV) proteins), bacterial proteins and eukaryotic proteins. Additionally, the inventions can be employed in the production of viruses and viral vectors, for example parvovirus, dependovirus, lentivirus, herpesvirus, adenovirus, AAV, and poxvirus.

The inventions also are applicable to production of biosimilar products. Biosimilar products, often referred to as follow on products, are defined in various ways depending on the jurisdiction, but share a common feature of comparison to a previously approved biological product in that jurisdiction, usually referred to as a “reference product.” According to the World Health Organization, a biosimilar product (‘biosimilar’) is currently a biotherapeutic product similar to an already licensed reference biotherapeutic product in terms of quality, safety and efficacy, and currently is followed in many countries, such as the Philippines.

A biosimilar in the U.S. is currently described as (A) a biological product is highly similar to the reference product notwithstanding minor differences in clinically inactive components; and (B) there are no clinically meaningful differences between the biological product and the reference product in terms of the safety, purity, and potency of the product. In the U.S., an interchangeable biosimilar or product that is shown that may be substituted for the previous product without the intervention of the health care provider who prescribed the previous product. In the European Union, a biosimilar is currently a biological medicine highly similar to another biological medicine already approved in the EU (called “reference medicine”) in terms of structure, biological activity and efficacy, safety and immunogenicity profile (the intrinsic ability of proteins and other biological medicines to cause an immune response), and these guidelines are followed by Russia. In China, a biosimilar currently refers to biologics that contain active substances similar to the original biologic drug and is similar to the original biologic drug in terms of quality, safety, and effectiveness, with no clinically significant differences. In Japan, a biosimilar currently is a product that has bioequivalent/quality-equivalent quality, safety, and efficacy to an reference product already approved in Japan. In India, biosimilars are currently referred to as “similar biologics,” and refer to a similar biologic product is that which is similar in terms of quality, safety, and efficacy to an approved reference biological product based on comparability. In Australia, a biosimilar medicine currently is a highly similar version of a reference biological medicine. In Mexico, Columbia, and Brazil, a biosimilar currently is a biotherapeutic product that is similar in terms of quality, safety, and efficacy to an already licensed reference product. In Argentina, biosimilar currently is derived from an original product (a comparator) with which it has common features. In Singapore, a biosimilar currently is a biological therapeutic product that is similar to an existing biological product registered in Singapore in terms of physicochemical characteristics, biological activity, safety and efficacy. In Malaysia, a biosimilar currently is a new biological medicinal product developed to be similar in terms of quality, safety and efficacy to an already registered, well established medicinal product. In Canada, a biosimilar currently is a biologic drug that is highly similar to a biologic drug that was already authorized for sale. In South Africa, a biosimilar currently is a biological medicine developed to be similar to a biological medicine already approved for human use. Biosimilars and its synonyms under these and any revised definitions are within the scope of the inventions.

It is to be understood that the description, specific examples and data, are given by way of illustration and are not intended to limit the present inventions. Various changes and modifications within the present invention, including combining features in whole and in part, will become apparent to the skilled artisan from the discussion, disclosure and data contained herein, and thus are considered part of the invention.

1. A method of operating a chromatography column, comprising performing generalized linear model (GLM) to a set of values of a system suitability parameter (SSP), wherein the set of values of the SSP is obtained from an initial run and one or more subsequent runs of an analyte through the columns.

2. The method of claim 1, wherein the slope of the linear regression line produced by the GLM indicates performance of the column compared to the initial condition of the column at the initial run.

3. The method of claim 1, wherein the method comprises measuring the values of the SSP in the initial and subsequent runs.

4. The method of claim 1, wherein the slope of the linear regression line indicates rate of column degradation or rate of column aging.

5. The method of claim 1, wherein the SSP is selected from the group consisting of:
a) retention time;
b) peak height and/or peak width;
c) tailing factor;
d) asymmetry factor;
e) resolution;
f) plate count;
or any combination thereof.

6. The method of claim 1, comprising making a determination that the performance of the column is acceptable if the set of values of the SSP fits a linear model.

7. The method of claim 1, comprising making a determination that the performance of the column is not acceptable if the set of values of the SSP does not fit a linear model.

8. The method of claim 7, wherein the set of values of the SSP fits an exponential model better than a linear model.

9. The method of claim 1, wherein the generalized linear model has the following equation:
$$\hat{y} = β 0 + β1 \times 1 + β2 \times 2 ;$$
wherein x1 is run number, ŷ is the estimated SSP value at the x1-th run, β0 is the estimated average intercept, β1 is the estimated slope of the linear regression line, and β2x2 is the estimated correction for variability between different lots of columns, wherein β0 and β1 are regression coefficients that are computed to minimize residual sum of squares, optionally wherein the term β2x2 is removed from the GLM equation.

10. The method of claim 9, further comprising determining R-squared (R²) value as a goodness-of-fit measure.

11. The method of claim 10, comprising making a determination that the performance of the column is not acceptable if the R² value is smaller than a predetermined threshold value.

12. The method of claim 11, wherein the predetermined threshold value is 0.7.

13. The method of claim 1, further comprising replacing the column or repacking the column stationary phase particles.

14. A method of monitoring a column, comprising performing generalized linear model (GLM) to a set of values of a system suitability parameter (SSP), wherein the set of values of the SSP is obtained from an initial run and one or more subsequent runs of an analyte through the column.

15. The method of claim 14, wherein the slope of the linear regression line produced by the GLM indicates performance of the column compared to the initial condition of the column at the initial run, or wherein the slope of the linear regression line indicates rate of column degradation or rate of column aging.

16.-17. (canceled)

18. The method of claim 14, wherein the SSP is selected from the group consisting of:
a) retention time;
b) peak height and/or peak width;
c) tailing factor;
d) asymmetry factor;
e) resolution;
f) plate count;
or any combination thereof.

19. The method of claim 14, comprising making a determination that the performance of the column is acceptable if the set of values of the SSP fits a linear model, or making a determination that the performance of the column is not acceptable if the set of values of the SSP does not fit a linear model.

20.-21. (canceled)

22. The method of claim 14, wherein the generalized linear model is:
$$\hat{y} = β 0 + β1 \times 1 + β 2 \times 2 ;$$
wherein x1 is run number, ŷ is the estimated SSP value at the x1-th run, β0 is the estimated average intercept, β1 is the estimated slope of the linear regression line, and β2x2 is the estimated correction for variability between different lots of columns, wherein β0 and β1 are regression coefficients that are computed to minimize residual sum of squares, optionally wherein the term β2x2 is removed from the GLM equation.

23.-26. (canceled)

27. A method of operating a chromatography column, comprising determining percent change of a SSP between an initial run and a subsequent run of an analyte through the column.

28. The method of claim 27, wherein the SSP is selected from the group consisting of:
a) retention time;
b) peak height and/or peak width;
c) tailing factor;
d) asymmetry factor;
e) resolution;
f) plate count;
or any combination thereof.

29. The method of claim 27, wherein a positive percent change of retention time, peak width and/or tailing factor indicates decreasing column performance, or a negative percent change of peak height, resolution and/or plate count indicates decreasing column performance.

30. (canceled)

31. The method of claim 27, comprising making a determination that the performance of the column is not acceptable if the percent change of the SSP exceeds a reference level.

32. The method of claim 31, wherein the percent change of the SSP exceeding a reference level is one or more selected from the group consisting of:
a) the percent change is great than 2.3% if the SSP is retention time;
b) the percent change is great than 12% if the SSP is peak width;
c) the percent change is great than 10% if the SSP is tailing factor;
d) the percent change is great than 15.75% if the SSP is asymmetry factor;
e) the percent change is smaller than −9.8% if the SSP is peak height;
f) the percent change is smaller than −10.5% if the SSP is resolution; and
g) the percent change is smaller than −18.5% if the SSP is plate count.

33. The method of claim 27, further comprising making a determination that the performance of the column is acceptable and continuing using the column.

34. The method of claim 33, wherein the determination that the performance of the column is acceptable is made when the percent change of the SSP is equal to or exceeds a reference level.

35. The method of claim 34, wherein the percent change of the SSP being equal to or exceeding a reference level is one or more selected from the group consisting of:
a) the percent change is equal to or lower than 2.3% if the SSP is retention time;
b) the percent change is equal to or lower than 12% if the SSP is peak width;
c) the percent change is equal to or lower than 10% if the SSP is tailing factor;
d) the percent change is equal to or lower than 15.75% if the SSP is asymmetry factor;
e) the percent change is equal to or greater than −9.8% if the SSP is peak height;
f) the percent change is equal to or greater than −10.5% if the SSP is resolution; and
g) the percent change is equal to or greater than −18.5% if the SSP is plate count.

36. The method of claim 27, further comprising replacing the column or repacking the column stationary phase particles.

37.-54. (canceled)
